(19) United States
(12) Patent Application Publication
(10) Pub. No.: US 2015/0242146 A1
(43) Pub. Date: Aug. 27, 2015

(54) STORAGE CONTROL APPARATUS AND STORAGE SYSTEM

(71) Applicant: FUJITSU LIMITED, Kawasaki-shi (JP)

(72) Inventors: YOSHINARI SHINOZAKI, Kawasaki (JP); HIDENORI YAMADA, Kita (JP)

(21) Appl. No.: 14/608,931

(22) Filed: Jan. 29, 2015

(30) Foreign Application Priority Data
Feb. 27, 2014 (JP) 2014-036919

(51) Int. Cl. G06F 3/06

(52) U.S. Cl. CPC G06F 3/0619; G06F 3/065; G06F 3/067

(57) ABSTRACT

A storage control apparatus includes a first storage unit that store data to be written data in a first storage device, a processor which executes a process including acquiring a first free space used for writing the data when a request to write data in the first storage unit is given, writing the data in the first storage unit, requesting that a transfer-destination storage control apparatus acquire a second free space used for writing the data before writing the data in the first storage unit in the writing process has been completed, the transfer-destination storage control apparatus being provided with a second storage unit for storing data to be written in a second storage device, and transferring the data written in the first storage unit to the transfer-destination storage control apparatus.

### CROSS-REFERENCE TO RELATED APPLICATION

This application is based upon and claims the benefit of priority of the prior Japanese Patent Application No. 2014-0036919, filed on Feb. 27, 2014, the entire contents of which are incorporated herein by reference.

### FIELD

The embodiments discussed herein are related to a data backup technology.

### BACKGROUND

In order to minimize damage due to a disaster or the like in a storage system, a remote location backup technique is used for a storage device in which, when data stored at a storage device in an operation system is updated, updated content of the data are stored in a storage device in a standby system at a remote location in synchronization with the storage device in the operation system. As a remote location backup technique, a Remote Equivalent Copy (REC), for example, is available. As a storage device, a Hard Disk (HD), for example, is available. In the descriptions below, a storage device in an operation system can be called a copy-source storage device (primary storage device). A storage device in a standby system can be also called a copy-destination storage device (secondary storage device). A remote location backup technique is simply called a backup. Further, a technique to minimize damage caused by a disaster can be called a disaster recovery.

In a storage system, when data is written in the copy-source storage control device from a host computer such as a server, a transfer-source storage device is provided with a cache memory for temporally storing the data to be written in the copy-source storage device. In the description below, a host computer can simply be called a host. A cache memory can be called a cache. A cache provided with a transfer-source storage control device can be called a primary cache.

Further, in a storage system, when data transferred from a transfer-source storage control device is written in a copy-destination storage device, a transfer-destination storage control device provided with a cache memory to temporarily store the data to be stored in the copy-destination storage device is used. In the description below, a cache storage with a transfer-destination storage device can be called a secondary cache.

If there is a request from a host to write data, the transfer-source storage control device acquires a free space in a primary cache for writing data. When the acquisition of the free space in the primary cache is completed, the transfer-source storage control device obtains data from the host and writes the obtained data to the acquired free space of the primary cache. Upon completing the acquisition of the free space in the primary cache, the transfer-source storage control device then requests that the transfer-destination storage control device acquire a free space in the secondary cache. In the descriptions below, the free space in the primary cache can be called a primary free space. Further, the free space in the secondary cache can be called a secondary free space.

When the transfer-destination storage control device receives an acquisition request from the transfer-source storage control device, the transfer-destination storage control device acquires the secondary cache.

When the transfer-destination storage control device completes the acquisition of the secondary cache, the transfer-source storage control device starts transferring data stored in the primary cache to the transfer-destination storage control device.

As described above, in a storage system, updated contents of a copy-source storage device are copied in a copy storage by using a transfer-source storage control device and a transfer-destination storage control device. With this, in a storage system, stored contents of a copy-source storage device are backed up in a copy-destination storage device.

As a related technology, a Storage Logical Partition (SLPR), which is an exclusive space for each user, is set up in a disc array device. Each SLPR is a division consisting of various resources, such as a port, a cache memory and a logic device, and a host computer cannot access an unauthorized SLPR. Further, a manager of each SLPR cannot refer to or change a structure of any other SLPR. At a remote copy time, a transfer quantity in a unit time is detected in each SLPR. A technology is known such that, if the transfer quantity in a unit time exceeds the maximum transfer quantity, a response from the SLPR to a host computer is intentionally delayed to suppress data inflow from the host computer.

As another related technology, a logic volume is divided into a plurality of small areas called logic storage devices, the only areas designated by a user that are subjected to a remote copy and a shift copy. Further, a technology is known such that means to configure a logic volume are provided from arbitrary logic storage devices in arbitrary RAID groups.

As still another technology, a communication memory area of a mask storage device is provided with a usable buffer composed of a plurality of memory buffers and an in-use buffer composed of a plurality of memory buffers allocated for communication. A buffer control unit secures a reservation buffer corresponding to a reservation size designated by a usable buffer upon receiving a buffer reservation request from a storage management device. The buffer control unit allocates a memory buffer that is in the reservation buffers in response to a remote copy start request from the storage management device and makes the memory buffer an in-use buffer. A technology is known such that a remote copy unit executes a remote copy between the remote copy unit and a remote storage device by using an in-use buffer.

As even still another technology, a copy source device is provided with an identification information acquisition unit to obtain reception buffer identification information used to identify reception buffer identification provided in a copying device and a transmission buffer to store data transferred to the reception buffer. Further, a copy source device is provided with a data transfer control unit that makes a transmission buffer correspond to a reception buffer in accordance with transmission information and reception information set in a transmission buffer in the case when a transferring process is executed. In addition, a technology is known such that a copy source device is provided with a transfer processing unit to transfer data of a transmission buffer to a reception buffer in accordance with the correspondence (for example, Japanese Unexamined Patent Publication 2005-190057, Japanese Unexamined Patent Publication 2000-132343, Japanese Unexamined Patent Publication 2005-122235, Japanese Unexamined Patent Publication 2010-244583).

In the storage control technologies described above, a backup process time may take a long time if the acquisition of a primary free space or writing data in the primary free space takes a long time, and a starting time for other processing may be delayed.

### SUMMARY

According to an aspect of the embodiments, A storage control apparatus includes a first storage unit that store data to be written data in a first storage device, a processor which executes a process including acquiring a first free space used for writing the data when a request to write data in the first storage unit is given, writing the data in the first storage unit, requesting that a transfer-destination storage control apparatus acquire a second free space used for writing the data before writing the data in the first storage unit in the writing process has been completed, the transfer-destination storage control apparatus being provided with a second storage unit for storing data to be written in a second storage device, and transferring the data written in the first storage unit to the transfer-destination storage control apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a functional block diagram illustrating an embodiment of a storage control apparatus;

FIG. 2 is a block diagram illustrating an embodiment of a storage system;

FIG. 3 is a diagram illustrating an example of a communication route;

FIG. 4 is a diagram illustrating an example of a backup process in a synchronous process;

FIG. 5 is a diagram illustrating a data transfer time for a backup process in a synchronous process;

FIG. 6 is a diagram (No. 1) illustrating an example of a backup process in an asynchronous process;

FIG. 7 is a diagram (No. 2) illustrating an example of a backup process in an asynchronous process;

FIG. 8 is a diagram (No. 3) illustrating an example of a backup process in an asynchronous process;

FIG. 9 is a diagram (No. 4) illustrating an example of a backup process in an asynchronous process;

FIG. 10 is a diagram illustrating a difference in process time between a synchronous process and an asynchronous process;

FIG. 11 is a flowchart (No. 1) illustrating processes performed by a transfer-destination storage control apparatus;

FIG. 12 is a flowchart (No. 2) illustrating a processes performed by a transfer-destination storage control apparatus;

FIG. 13 is a flowchart (No. 3) illustrating a processes performed by a transfer-destination storage control apparatus;

FIG. 14 is a flowchart (No. 4) illustrating a processes performed by a transfer-destination storage control apparatus;

FIG. 15 is a flowchart (No. 5) illustrating a processes performed by a transfer-destination storage control apparatus;

FIG. 16 is a flowchart (No. 6) illustrating a processes performed by a transfer-destination storage control apparatus;

FIG. 17 is a flowchart (No. 7) illustrating a processes performed by a transfer-destination storage control apparatus;

FIG. 18 is a flowchart illustrating a processes acquiring a free space performed by a transfer-destination storage control apparatus;

FIG. 19 is a flowchart (No. 1) illustrating a processes acquiring a free space performed by a relay-destination storage control apparatus; and

FIG. 20 is a flowchart (No. 2) illustrating a processes acquiring a free space performed by a relay-destination storage control apparatus.

### DESCRIPTION OF EMBODIMENTS

Embodiments of a storage control apparatus will be described below.

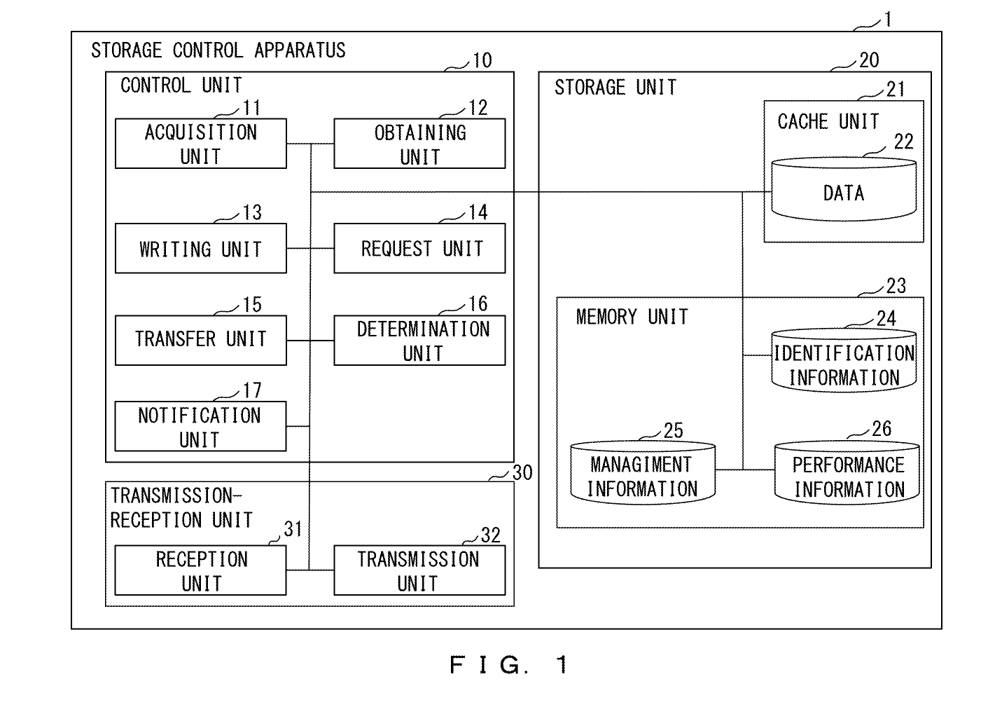

FIG. 1 is a functional block diagram of an embodiment of a storage control apparatus.

An embodiment of a storage control apparatus will be described with reference to FIG. 1. Functions of the transfer-source storage control apparatus 1, the transfer-destination storage control apparatus 2, the relay-destination storage device 3 contained in the same housing as the transfer-source storage control apparatus 1, and the relay-destination storage device 4 contained in the same housing as the transfer-destination storage control apparatus 2, will be described below.

Further, the transfer-source storage control apparatus 1 is a storage control apparatus connected to a copy-source storage device. The transfer-destination storage control apparatus 2 is a storage device connected to a copy-destination storage device. The relay-destination storage device 3 and the relay-destination storage device 4 are storage control apparatuses that relay transmission and reception of data and various requests between the transfer-source storage control apparatus 1 and the transfer-destination storage device 2.

Since the transfer-source storage control apparatus 1, the transfer-destination storage control apparatus 2, the relay-destination storage control apparatus 3, and the relay-destination storage device 4 have the same function, the function of the transfer-source storage control apparatus 1 will be described as an example.

The transfer-source storage control apparatus 1 is provided with a control unit 10, a storage unit 20, and a transmission-reception unit 30, for example. The transfer-source storage control apparatus 1 is a control module, for example.

The control unit 10 includes an acquisition unit 11, an obtaining unit 12, a writing unit 13, a request unit 14, a transfer unit 15, a determination unit 16, and a notification unit 17. The storage unit 20 includes a cache unit 21 and a memory unit 23. The cache unit 21 temporarily stores data 22 to be written in a copy-source storage unit. The memory unit 23 stores identification information 24, management information 25, and performance information 26. The transmission-reception unit 30 includes a reception unit 31 and a transmission unit 32. The data means all data to be written in a copy-source storage device upon receiving a writing request.

The acquisition unit 11 acquires the first free space in the first storage unit when a request to write the data 22 in a copy-source storage device is provided from a host. The first storage unit is the storage unit 20 with which the transfer-source storage control apparatus 1 is provided. Further, the first free space is a portion of a storage space of the cache unit 21 included in the first storage, for example. When the writing request is transmitted from a host and is received by the reception unit 31, the writing request is given to the acquisition unit 11, the request unit 14, the transfer unit 15, and the determination unit 16. Further, information with respect to an identification number of a writing-reception storage device for the data 22, a data size to be written, or the like is provided to the writing request. It is acceptable for the writing request to be provided with information indicating whether the data 22 is backup data or not and category information indicating whether a backup process is executed by a synchronous type or an asynchronous type.

The obtaining unit 12 obtains the data 22 when the acquisition unit 11 acquires the first free space. The obtaining unit 12 requests a host to obtain the data 22 when the acquisition unit 12 acquires the first free space. Thus, the obtaining unit 12 may obtain the data 22 as a response from a host.

The writing unit 13 writes the data 22 that the obtaining unit 12 obtains from a host in the first storage unit.

The request unit 14 requests that the transfer-destination storage control apparatus 2 provided with the second storage unit acquire the second free space of the second storage unit used for writing the data 22 before the data 22 is written in the first storage unit by the writing unit 13. The second storage unit is the storage device 20 with which the transfer-destination storage control apparatus 2 is provided, and it stores the data 22 to be written in the second storage device.

The request unit 14 may determine whether or not an acquisition time from when a request to write the data 22 is given to the acquisition of the first free space acquired by the acquisition unit 11 is equal to or greater than the first threshold value. The request unit 14 may then request that the transfer-destination storage control apparatus 2 acquire the second free space when the acquisition time is greater than the threshold time and before the writing unit 13 has completed writing the data 22 in the first storage unit. The first threshold value can be appropriately set up to shorten an overhead time in an asynchronous backup process in a storage system, for example.

Further, the request unit 14 may determine whether a writing time for the writing unit 13 to complete the writing of the data 22 in the first storage device is equal to or greater than the second threshold value. The request unit 14 may then request that the transfer-destination storage control apparatus 2 acquire the second free space when the acquisition time is greater than the second threshold time and before the writing unit 13 has completed writing the data 22 in the first storage unit. The second threshold value can be appropriately set up to shorten an overhead time in an asynchronous backup process in a storage system, for example.

Further, the request unit 14 may determine whether a transfer preparation time from a request for the writing of the data 22 to the completion of writing of the data 22 in the first storage unit by the writing unit 13 is equal to or greater than the fifth threshold value. The request unit 14 then requests that the transfer-destination storage control apparatus 2 acquire the second free space if the time taken up to the completion of writing the data 22 is greater than the fifth threshold value, before the writing unit 13 completes writing the data 22 in the first storage unit. The fifth threshold value can be appropriately set up to shorten an overhead time in an asynchronous backup process in a storage system, for example.

The transfer unit 15 transfers the data 22 written in the first storage to the transfer-destination storage control apparatus 2.

Further, the transfer unit 15 may transfer a specified quantity of data to a transfer-destination storage control apparatus when not less than a specified quantity of data in the data 22 that the writing unit 13 writes in the first storage device is written in the first storage unit. In the description below, a specified quantity of data is also called divided data. Specified data may be unit data of Direct Storage Access (DMA) transfer or unit data of a cache page where data is written. Further, the specified data may be a plurality of pieces of DMA unit data or a plurality of pieces of unit data of a cache where the data 22 is written. A size of the specified quantity of data can be appropriately set up to shorten an overhead time in an asynchronous backup process.

The transfer unit 15 may determine whether a response time from when a request for the writing of the data 22 is given to a completion of the transfer of the data 22 to be written in the first storage device to the transfer-destination storage control apparatus 2 is equal to or greater than the third threshold value. Then, when the response time is equal to or greater than the third threshold and when a specified quantity of data or greater of the data 22 is written in the first free space, a specified quantity of data is transferred to the transfer-destination storage control apparatus 2. A size of the third threshold value can be appropriately set to shorten an overhead time in an asynchronous backup process in a storage system, for example.

The transfer unit 15 may determine whether a writing time for the writing unit 13 to complete the transfer of the data 22 to be written in the first storage device from the acquisition of the first free space is equal to or greater than the fourth threshold value. Then, when the writing time is equal to or greater than the fourth threshold and when a specified quantity of data or greater of the data 22 is written in the first free space, the transfer unit 15 transfers a specified quantity of data to the transfer-destination storage control apparatus 2. A size of the fourth threshold value can be appropriately set to shorten an overhead time in an asynchronous backup process in a storage system, for example. Note that the fourth threshold value may be the same period of time as the second threshold value.

The transfer unit 15 may determine whether a transfer time for the writing unit 13 to complete the writing of the data 22 to be written in the first storage device from the completion of writing of the data 22 in the first free space is equal to or greater than the sixth threshold value. Then, in the case where the response time is equal to or greater than the sixth threshold value and when a specified quantity of data or greater of the data 22 is written in the first free space, the transfer unit 15 transfers a specified quantity of data to the transfer-destination storage control apparatus 2. A size of the sixth threshold value can be appropriately set to shorten an overhead time in an asynchronous backup process in a storage system, for example.

The determination unit 16 determines a communication route to transfer the data 22 or a request to the transfer-destination storage control apparatus 2. The determination of the communication route by the determination unit 16 will be described later.

The notification unit 17 notifies a storage control apparatus on the communication route of the communication route determined by the determination unit 16. The storage control apparatuses on the communication route unit 17 are the transfer-destination storage control apparatus 2, the relay-destination storage control apparatus 3, and the relay-destination storage control apparatus 4, for example.

Here, a function different from the function of the transfer-source storage control apparatus 1 from among the functions of the transfer-destination storage control apparatus 2, the relay-destination storage control apparatus 3, and the relay-destination storage control apparatus 4 will be described.

The second acquisition unit with which the transfer-destination storage control apparatus 2 is provided acquires the second free space from the second storage unit when the second acquisition unit receives a request for the acquisition of the second free space from the transfer-source storage control apparatus 1.

In the transfer-source storage control apparatus 1, the determination unit 16 determines a communication route by which to transfer the data 22 to the transfer-destination storage control apparatus 2 through the relay-destination storage control apparatus 3. Further, the request unit 14, before the writing unit 13 completes the writing of the data 22 in the first storage, requests that the relay-destination storage control apparatus 3 with which the third storage unit for storing the data 22 to be relayed is provided acquire the third free space of the third storage unit to be used for the writing of the data 22. The third acquisition unit with which the relay-destination storage control apparatus 3 is provided then acquires the third free space of the third storage unit when the third acquisition unit receives the acquisition request of the third free space. Further, the third request unit with which the relay-source storage control unit 3 is provided refers to a communication route reported by the notification unit 17 before the completion of the acquisition of the third free space by the third acquisition unit and requests that the transfer-destination storage control unit 2 acquire the second free space. Note that a communication process in which the transfer-source storage control apparatus 1 transfers the data 22 to the transfer-destination storage control apparatus 2 through the relay-source storage control unit 3 is called a cross-access.

In the transfer-source storage control apparatus 1, the determination unit 16 determines a communication route by which to transfer the data 22 to the transfer-destination storage control apparatus 2 through the relay-destination storage control apparatus 4. Further, the request unit 14 requests that the relay-destination storage control apparatus 3 with which the fourth storage unit for storing the data 22 to be relayed is provided acquire the fourth free space of the fourth storage unit to be used for the writing of the data 22. The fourth acquisition unit with which the relay-destination storage control apparatus 4 is provided then acquires the fourth free space of the fourth storage unit when the fourth acquisition unit receives the acquisition request of the fourth free space. Further, the fourth request unit with which the relay-source storage control unit 4 is provided refers to a communication route reported by the notification unit 17 before the completion of the acquisition of the fourth free space by the fourth acquisition unit and requests that the transfer-destination storage control unit 2 acquire the second free space.

The cache storage unit 21 temporarily stores the data 22 that is obtained from a host and that is to be written in the copy-source storage.

The memory unit 23 stores various information used for backup processes.

Identification information 24 contains information indicating respective identification numbers of a plurality of storage devices with which a storage system is provided, for example. Further, identification numbers for copy-destination storage devices may be stored relating to information indicating a plurality of communication routes to transfer the data 22 from the storage control apparatus 1 to a copy-destination storage device. The determination unit 16 may refer to a plurality of communication routes in relation to the identification information 24 of copy-destination storage devices stored in the identification information 24 when a writing request is given by a host, for example. The determination unit 16 determines a communication route in accordance with a round robin or a usage rate in the past, for example, and may deal with a load dispersion of a transfer process of the data 22.

Further, the transfer unit 15 may designate an identification number of a copy-destination storage device stored in the identification information 24 when a writing request is given by a host and transfer the data 22 to a the transfer-destination storage control apparatus 2. With this, the transfer-destination storage control apparatus 2 identifies a copy-destination storage device and writes the data 22 transferred from the transfer-source storage control apparatus 1 in a copy-destination storage device. The identification number may be a Logical Unit Number (LUN).

In the management information 25, within the data 22, information to identify data is stored in the first storage device, for example. That is, the management information 25 is information indicating a process status for writing the data 22 in the first storage device. The management information 25 may be bitmap data.

The performance information 26 is information indicative of a process time of each process calculated in the previous process, for example. An acquisition time, a writing time, a transfer preparation time, a response time, and a transfer time may be stored in the performance information 26. In the performance information 26, the first threshold value through the sixth threshold value may be stored. In the performance information 26, a cache hit rate (acquisition time), a response time (replay time), a writing capability (writing time), a throughput (transfer time), etc., are stored.

The request unit 14 may determine whether to make a request to the transfer-destination storage control apparatus 2 for the acquisition of the second free space by using time and threshold values stored in the performance information 26 before the writing unit 13 has completed writing the data 22 in the first storage unit. Further, the transfer unit 15 may determine by using the time and the threshold stored in the performance information 26 whether to transfer a specified quantity of data to the transfer-destination storage control apparatus 2.

The reception unit 31 receives a request transmitted from a host or a storage control apparatus.

The transmission unit 32 transmits the data 22 or a request to a host or other storage control apparatuses.

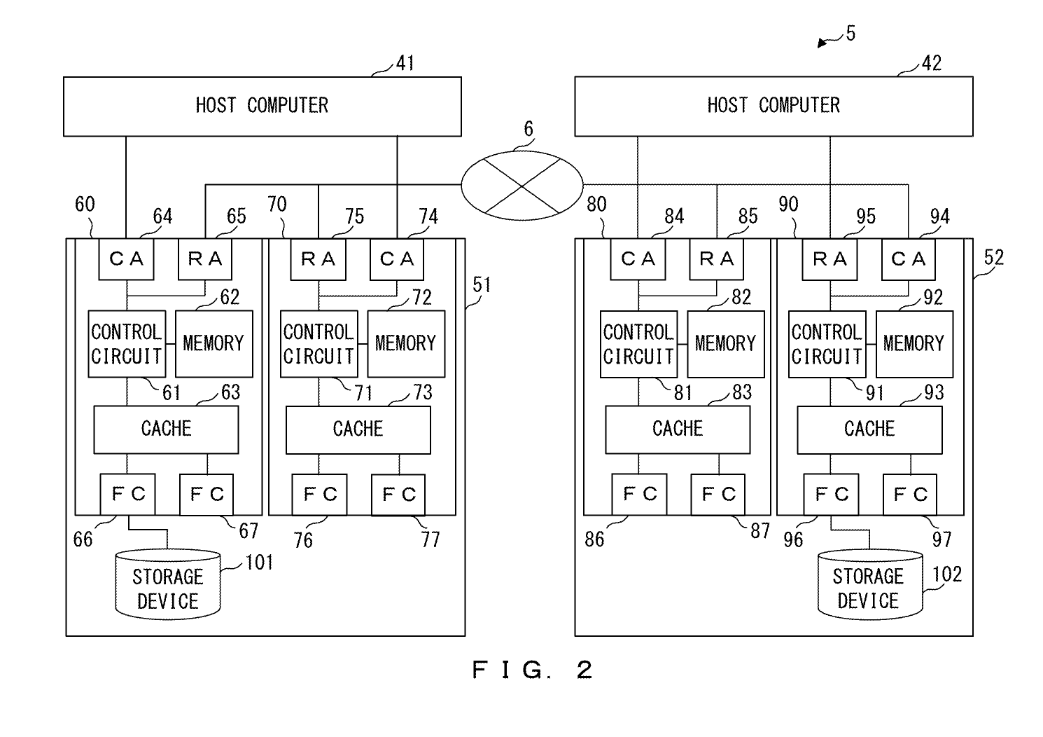

FIG. 2 is a block diagram illustrating an embodiment of a storage system.

The embodiment of the storage system will be described with reference to FIG. 2. For the simplification of descriptions, two housings are provided for a storage system 5 as an example but three or more housings can be provided.

The storage system 5 is provided with host computers 41 and 42 and housings 51 and 52. The housing 51 is provided with control modules 60 and 70 and a copy-source storage device 101. The housing 52 is provided with control modules 80 and 90 and a copy-destination storage device 102. Note that a plurality of storage devices, which are not illustrated in the diagram, may be connected to each of the control modules 60 through 90.

Further, the housings 51 and 52 are connected so as to be able to communicate with each other through a network 6. In the description below, host computers 41 and 42 can also be called hosts 41 and 42, respectively. Further, the control modules 60 through 90 are also called CM 60 through CM 90.

The host 41 is a server, for example, for transmitting a writing request to which an identification number is given and the data 22. Since the host 42 is the same in structure as the host 41, the description thereof is omitted.

The housing 51 is a storage device, for example, with which control modules 60 and 70 and a storage device 101 are provided. Since the housing 52 is the same in structure as the housing 51, the description thereof is omitted.

The CM 60 is provided with a control circuit 61, a memory 62, a cache 63, a CA 64, an RA 65, and FCs 66 and 67. Further, the CM 60 functions as the storage control apparatus 1 of FIG. 1. Since the CM 70 through the CM 90 are the same in structure as the CM 60, the description thereof is omitted. The CM 70 functions as the relay-destination storage control apparatus 3, for example. Further, the CM 80 functions as the relay-destination storage control apparatus 4, for example. The CM 90 functions as the transfer-destination storage control apparatus 2, for instance. In the description below, the transfer-source storage control apparatus 1 is also called the CM 60. The transfer-destination storage control apparatus 2 is also called the CM 90. The relay-destination storage control apparatus 3 is also called the CM 70. The relay-destination storage control apparatus 4 is also called the CM 80.

The control circuit 61 entirely controls a Controller Module (CM)). The control circuit 61 is a processor, such as a CPU, a multiple-core CPU, a Field Programmable Gate Array (FPGA), and a Programmable Logic Device (PLD). The control circuit 61 functions as the control unit 10 in FIG. 1, for example. Note that the data 22, the identification information 24, the management information 25 and the performance information 26 stored in the storage 20 may be stored in a cache of a CPU, an FPGA, or a PLD.

The memory 62 stores therein various data. Further, the memory 62 consists of a semiconductor memory such as a Read Only Memory (ROM) and a Random Access Memory (RAM) or a Hard Disk (HD). The memory 62 functions as the memory unit 23 in FIG. 1, for example. Further, the memory 62 may store the identification information 24, the management information 25, and the performance information 26. Note that the memory 62 may function as the cache unit 21 in FIG. 1, for example. In this case, the memory 62 may store the data 22 illustrated in FIG. 1.

Further, the ROM stores a program such as a boot program. The RAM is used for a work area of the control circuit 61. The HD stores a program such as an OS, application programs, or firmware, and various data.

The memory 62 stores a storage control program to make the control unit 10 function as the control unit 10, for example.

When executing a storage controlling, the storage control apparatus 1 reads out the storage control program stored in the memory 62 to the RAM. The control circuit 61 then carries out the storage control program read out to the RAM, so that the storage control apparatus 1 executes a storage controlling.

Note that the storage control program may be stored in a storage device with which the host 41 is provided, if the control circuit 61 is accessible through a CA 64 that will be described later.

The cache 63 temporarily stores the data 22 that is transmitted from the host 41 and is stored in a storage device 101. The cache 63 consists of a semiconductor memory such as a Static Random Access Memory (SRAM) and a RAM, for example. Further, the cache 63 may store the data illustrated in FIG. 1, for example. Note that the cache may function as the memory 23 in FIG. 1, for example. In this case, the cache 63 may store the identification information 24, the management information 25, and the performance information 26 illustrated in FIG. 1, for example.

The Channel Adopter (CA) 64 is a communication interface to control communication with the host 41. The Remote Adapter (RA) 65 is a communication interface connected to an RA 85 of the CM 80 or an RA 95 of the CM 90 to control communication with the housing 52. The Fiber Channel (FC) 66 is a communication interface to control communication with a storage device. The CA 64, the RA 65, and the FC 66 function as the transmission-reception unit 30 in FIG. 1.

The network 6 is a LAN, a wireless communication device or the Internet, for example, to connect the CM 60 to other devices for communication.

Further, although not illustrated in the diagrams, the CM 60 may be provided with a book reading device, a recording medium, an input-output interface, a display device, and a bus.

The book reading device is controlled by the control circuit 61 through a bus and carries out reading/writing data of a removable recording medium. Further, the book reading device is a Floppy Disk Drive (FDD), a Compact Disc Drive (CDD), a Digital Versatile Disc Drive (DVDD), a Blue-ray (registered trademark) Disc Drive (BDD), a Universal Serial Bus (USB) or the like.

The recording medium stores various data. The recording medium stores a storage control program, for instance. Further, the recording medium may store the identification information 24, the management information 25, and the performance information 26.

Further, the recording medium is connected to the control circuit 61 through the book reading device and the bus to read/write data under control of the control circuit 61 with respect to the book reading device. Further, the recording medium is a non-transitory computer-readable recording medium such as a Floppy Disc (FD), a Compact Disc (CD), a Digital Versatile Disc (DVD), a Blue-ray Disc: registered trademark (BD), or a flash memory.

The input-output interface is connected to a keyboard, a mouse, a touch panel, and the like to output an input signal to the control circuit 61 when a signal indicative of various information is input through the connected devices. Further, the input-output interface outputs a signal to the connected devices when the signal indicative of various information output from the control circuit 61 is input.

The display device is connected to the input-output interface, for example, to display various information.

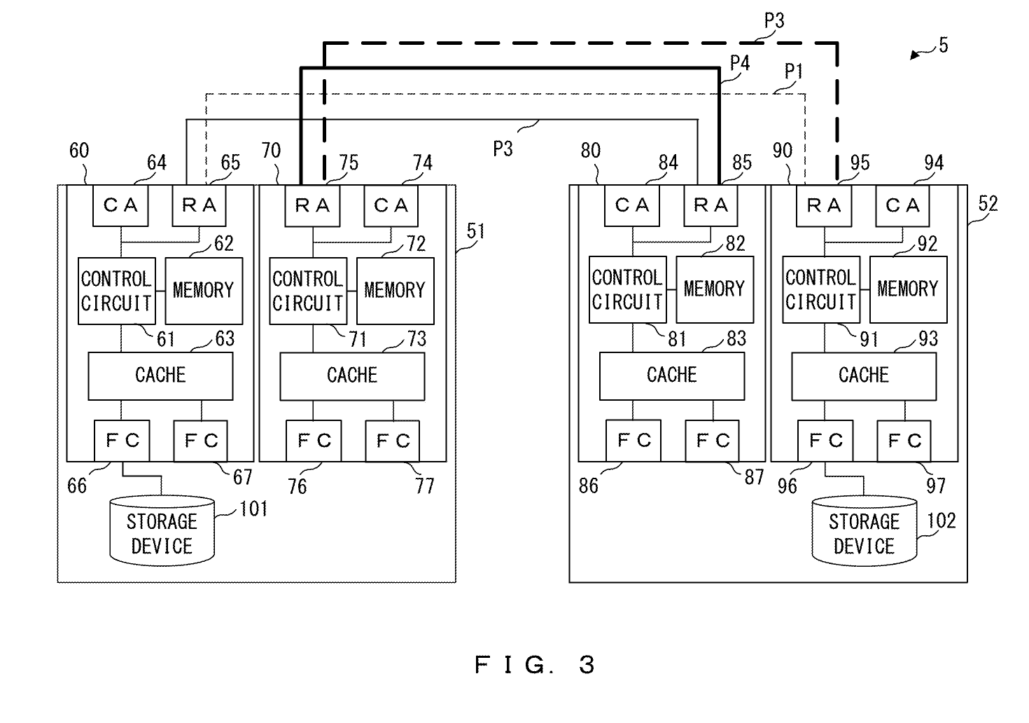

FIG. 3 is a diagram illustrating an example of a communication route.

The communication route used for a backup process will be described with reference to FIG. 3. In FIG. 3, a communication route is illustrated by way of example in the case where a storage device 101 is set up as a copy-source device and a storage device 102 connected to the CM 90 is set up as a copy-destination device.

As illustrated in FIG. 3, there are communication routes P1 through P4 in communication routes between the CM 60 and the CM 90. The communication route P1 is a communication route to directly communicate between the CM 60 and the CM 90. The communication route P2 is a communication route between the CM 60 and the CM 90 through the CM 70. The communication route P3 is a communication route between the CM 60 and the CM 90 through the CM 80. The communication route P4 is a communication route between the CM 60 and the CM 90 through the CM 70 and the CM 80. Information indicative of the communication routes P1 through P4 may be stored in the identification information 24 in relation to an identification number of the storage device 102 in the case when the storage device 101 connected to the CM 60 is set up to a copy-source device and the storage device 102 connected to the CM 90 is set up to a copy-destination device.

When the storage device 101 is set to the copy-source device and the storage device 102 is set to the copy-destination device, and when the CM 60 is not provided with the RA 65, for example, the only communication routes are the communication routes P2 and P4. In this case, information indicative of the communication routes P2 and P4 maybe stored in the identification information 24 in relation to the identification number of the storage device 102.

In addition when the storage device 101 is set to the copy-source device and the storage device 102 is set to the copy-destination device, and when the CM 90 is not provided with the RA 95, for example, the only communication routes are the communication routes P3 and P4. In this case, information indicative of the communication routes P3 and P4 maybe stored in the identification information 24 in relation to the identification number of the storage device 102.

As described above, if the communication route between the storage device 101 and the storage device 102 is set in the identification information, and when the data 22 received from the host 41 is transferred, the determination unit 16 can select a communication route from a plurality of communication routes. Further, the determination unit 16 determines a communication route from a plurality of communication routes in accordance with a round robin or a usage rate of communication routes in the past, so that the dispersion of process loads at the transfer of the data 22 can be performed.

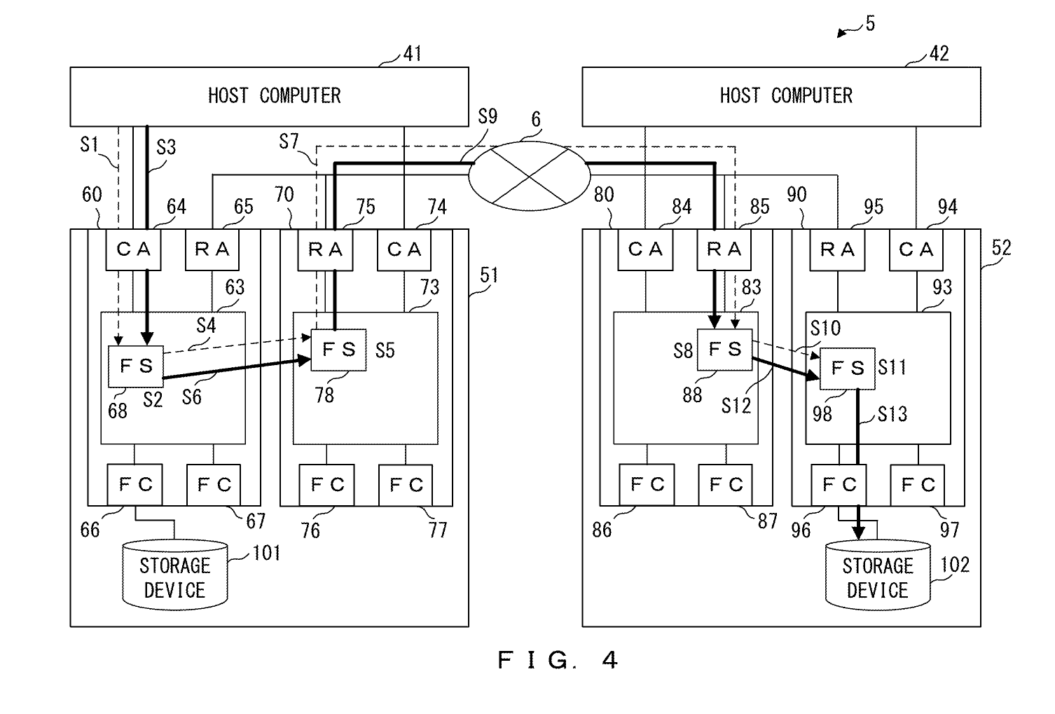

FIG. 4 is a diagram illustrating an example of a backup process in a synchronous process.

A backup process in accordance with a synchronous process will be described with reference to FIG. 4. The backup process in accordance with the synchronous process is a process in which a next process is executed in turn every time when a synchronous process is completed in each process included in the backup process.

FIG. 4 illustrates a process to transfer the data 22 from the CM 60 to the CM 90 through the CM 80. That is, FIG. 4 illustrates an example in which a process for the transfer of the data 22 is the most in the backup process. A storage system 5 in FIG. 4 is the same in structure as the storage system 5 in FIG. 2. In FIG. 4, the illustrations of a control circuit and a memory in each storage control apparatus are omitted for the simplification of descriptions.

When writing the data 22 in the copy-source storage device 101, the host 41 transmits a writing request to the CM 60 connected to the storage device 101 (S1).

Upon receiving the writing request, the CM 60 acquires the first free space 68 (FS: Free Space) of a cache 63 used for writing the data 22 and transmits a notification of completion of the acquisition of the first free space 68 (S2).

When the host 41 receives the notification of completion of acquisition of the first free space 68, the data 22 is transmitted to the CM 60 (S3).

Upon receiving the data 22, the CM 60 writes the data 22 in the cache 63. Upon completing the writing of the data 22, the CM 60 determines a communication route for transferring the data 22 and requests that the CM 70 acquire a third free space 78 of the cache 73 used for transferring the data 22 (S4). Further, the CM 60 notifies the CM 70, the CM 80 and the CM 90 on the communication route of the determined communication route. The CM 60 then may store the data 22 written in the cache 63 in the copy-source storage device 101 at a specified timing. The CM 60 may store the data 22 written in the cache 63 in the copy-source storage device 101 when the usage rate of the control circuit 61 is low, for example.

Upon receiving an acquisition request for a third free space 78, the CM 70 acquires the third free space 78 and transmits a notification of completion of the acquisition of the third free space 78 (S5).

Upon receiving the notification of the completion of the acquisition of the third free space 78, the CM 60 transmits the data 22 written in the first free space 68 to the CM 70 (S6). The CM 60 transmits a writing response to a writing request from the host 41. Upon receiving the writing response from the CM 60, the host 41 may terminate communication with the CM 60.

Upon receiving the data 22, the CM 70 writes the data 22 in the cache 73. Upon completion of writing the data 22, the CM 70 requests that the CM 80 acquire the fourth free space of the cache 83 used for transferring the data 22 to the CM 80 in accordance with a communication route reported by the CM 60 (S7).

Upon receiving the request for acquisition of a fourth free space 88, the CM 80 acquires the fourth free space 88 and notifies the CM 70 of the completion of the acquisition of the fourth free space 88 (S8).

Upon receiving the notification of completion of the acquisition of the fourth free space 88, the CM 70 transmits the data 22 written in the third free space 78 to the CM 80 (S9).

Upon receiving the data 22, the CM 80 writes the data 22 in the cache 83. Upon completion of writing the data 22, the CM 80 requests that the CM 90 acquire a second free space 98 so as to write the data 22 in accordance with a communication route reported by the CM 60 (S10).

Upon receiving the request for the acquisition of the second free space 98, the CM 90 acquires the second free space 98 and transmits a notification of completion of the acquisition of the second free space 98 (S11).

Upon receiving the completion of the acquisition of the second free space 98, the CM 80 transmits the data 22 written in the fourth free space 88 to the CM 90. Upon receiving the data 22, the CM then writes the data 22 in the cache 93 (S12).

Further, the CM 90 writes the data 22 written in the cache 93 in the storage device 102 (S13). The CM 90 then may notify the CM 60 of the receipt of the data 22 through a communication route used for the backup process. Note that the CM 90 may store the data 22 written in the cache 93 in the copy-destination storage device 192. The CM 90 may store the data 22 written in cache in the copy-destination storage device 102 at a specified timing. The CM 90 may store the data 22 written in the cache 93 in the copy-destination storage device 102 when the usage rate of the control circuit 91 is low.

As described above, the storage system 5 transfers the data 22 from the CM 60 to the CM 90, so that the same content as the storage content of the storage device 101 can be backed up in the storage device 102.

In the backup processes of the data 22 described with reference to FIG. 4, since the processes S1 through S13 are executed in order, a process time taken for the processes S1 through S13 is accumulated as a backup process time. The CM 60 transmits an I/O response to the host 41 when it is informed of the reception of the data from the CM 90, for example. Thus, the longer the backup process takes, the longer it takes for the CM 60 to return the I/O response.

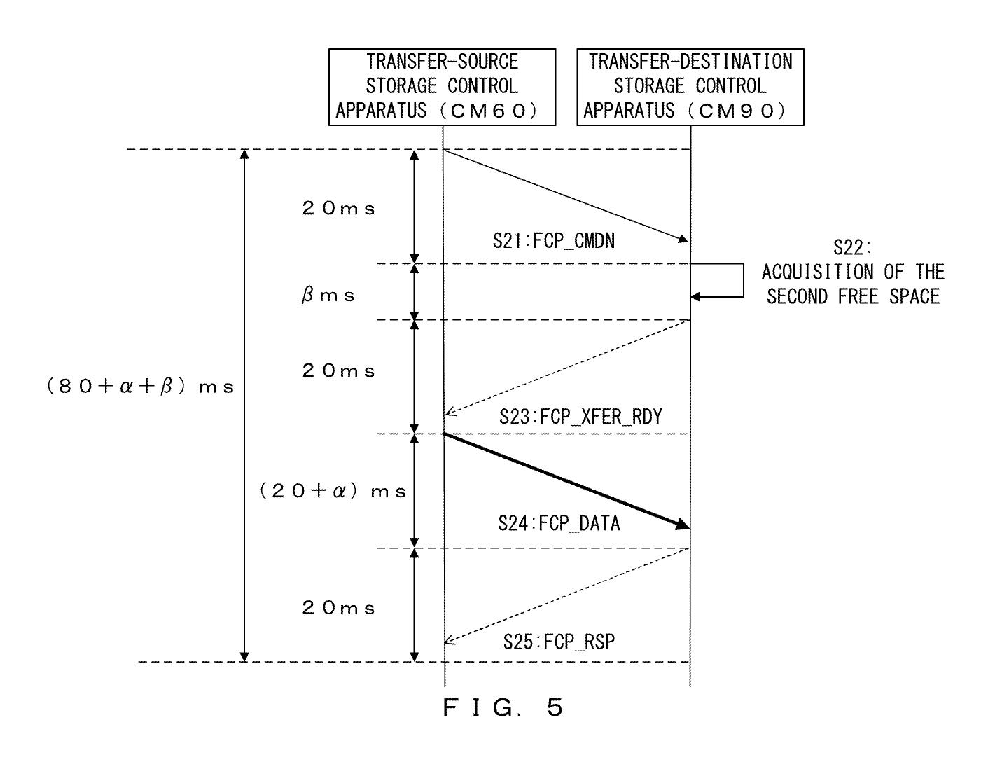

FIG. 5 is a diagram illustrating a data transfer time for a backup process in a synchronous process.

The process time needed for the backup process in the synchronous processes will be described with reference to FIGS. 4 and 5.

For simplification of the description, FIG. 5 illustrates an example of a transfer process in which the CM 60 of a copy-source storage control apparatus 1 directly transfers the data 22 to the CM 90 of a copy-destination storage control apparatus 2 in a backup process. The following descriptions will be given on the assumption that the CM 60 communicates with the CM 90 by means of a Small Computer System Interface Fiber Channel Protocol (SCSI-FCP) in the REC. Further, a Round-Trip delay Time (RTT) is deemed to be 40 ms, for example.

In the SCSI-FCP, the transmission-reception of the data 22 between the CM 60 and the CM 90 is carried out by using frames of the FCP_CMND, the FCP_XFER_RDY, the FCP_DATA, and the FCP_RSP.

First, the CM 60 uses the FCP_CMND (FCP Command) to request that the CM 90 acquire the second free space 98.

Upon receiving the FCP_CMND from the CM 60, the CM 90 acquires the second free space 98 (S22).

Upon completing the acquisition of the second free space 98, the CM 90 uses the FCP_XFER_RDY (FCP Ready) to notify the CM 60 of the completion of the acquisition of the second free space 98 (S 23). That is, the CM 90 notifies the CM 60 that it is ready for the reception of the data 22.

Upon receiving the FCP_XFER_RDY, the CM 60 uses an FCP_DATA to transmit the data written in the cache 63 prior to the FCP_CMND (S24).

Upon reception of the FCP_DATA, the CM 90 uses an FCP_RSP (FCP Reception) to notify the CM 60 of the reception of the data 22 (S25).

As described above, the CM 60 executes the processes S21 through S25 to transfer the data 22 to the CM 90.

Here, since the RTT between the CM 60 and the CM 90 is 40 ms, it takes 20 ms for each frame in the processes S21, S23 and S25 to carry out the transmission and reception. Further, a process time of β ms is needed for the acquisition of the second free space in the process S22 in accordance with a quantity of data of the data 22 to be written. Further, let us assume that the transmission-reception of the data 22 in the process S24 takes 20 ms and a process time of α ms is added in accordance with a data quantity of transferring data 22 and a bandwidth of the network 6.

Thus, if the backup process is executed in the synchronous process, it takes a process time of 80 ms+α ms+β ms for the transfer of the data 22 from the CM 60 to the CM 90.

Further, after writing the received data 22 in the second free space 98, the CM 25 executes the process S25. Hence, a writing time for the writing of the data 22 in the second free space 98 is added to the process time.

Further, in the case of a cross-access, and when the CM 60 transfers the data 22 to the CM 90, the process time for the acquisition of the third free space or the fourth free space in the CM 70 and the CM 90 is added.

Thus, the backup process is executed in the synchronous process and the time required for the acquisition of a free space and for writing data in a free space becomes longer, thereby causing such problems as a starting time for other processes being delayed and the backup process time becoming longer.

The storage control apparatus 1 of the embodiment requests that the transfer-destination storage control apparatus 2 acquire the second free space before the acquisition of the first free space is completed in the data transfer of a backup process, for example. With this, the storage control apparatus 1 of the embodiment makes the transfer-destination storage control apparatus 2 execute an acquisition process of the second free space when executing the acquisition of the first free space, thereby reducing the backup process time.

Further, when a specified quantity of data or greater of the data 22 is written in the first storage unit, the storage control apparatus 1 of the embodiment transfers the specified quantity of data to the transfer-destination storage control apparatus 2. With this, the storage control apparatus 1 of the embodiment makes a data transfer start time earlier and reduces the α ms of the process time added in accordance with a data quantity of the transferred data 22 and a bandwidth of the network 6, thereby reducing the backup process time.

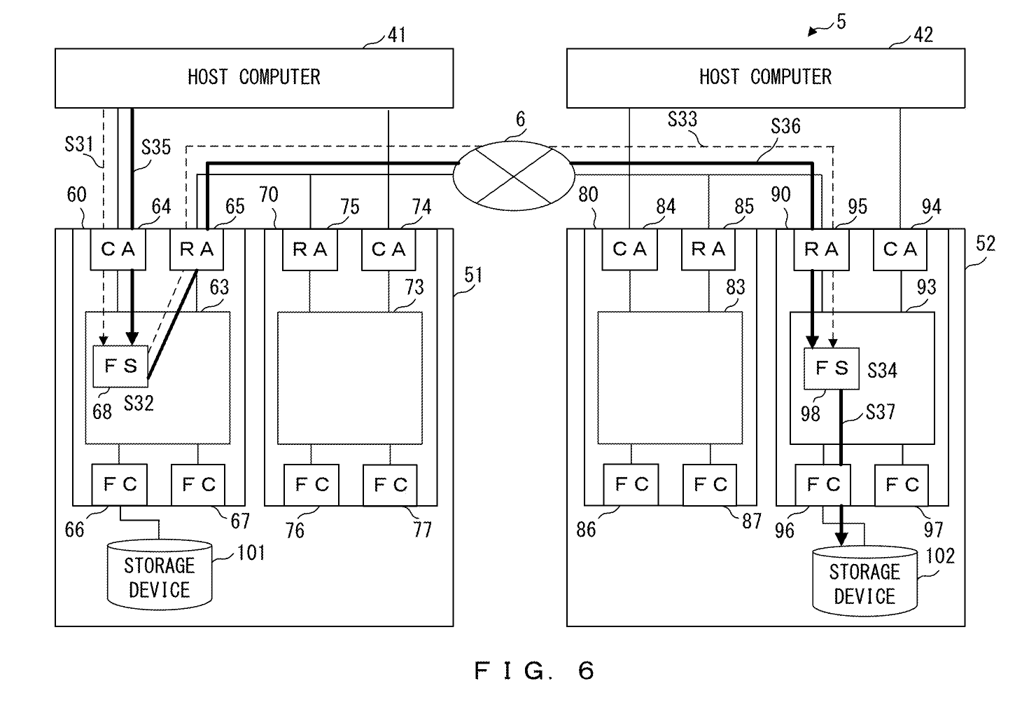

FIGS. 6 through 9 are diagrams illustrating an example of a backup process in an asynchronous process.

The asynchronous process means that a plurality of processes included in each process of the backup process are executed asynchronously.

Description will be given with reference to FIG. 6.

FIG. 6 illustrates a process for directly transferring the data 22 from the CM 60 to the CM 90. A storage system 5 of FIG. 6 is the same in structure as the storage system 5 of FIG. 2. Further, in order to simplify the descriptions, the illustration of a control circuit and a memory are omitted from each storage control apparatus in FIG. 6.

When writing the data 22 in the copy-source storage device 101, the host 41 transmits a writing request to the CM 60 connected to the storage device 101 (S31).

Upon reception of the writing request, the CM 60 starts the acquisition of the first free space of the cache 63 used for writing the data 22 (S32). Further, the CM 60 determines a communication route for transferring the data 22. Descriptions will be given on the assumption in FIG. 6 that a communication route has been determined for directly transmitting the data 22 from the CM 60 to the CM 90. Further, the CM 60 determines whether the response time is equal to or greater than the third threshold with reference to the performance information 26. In FIG. 6, descriptions will be given on the assumption that the response time is equal to or greater than the third threshold value. Hence, the CM determines that the data 22 be transferred by means of a divided transfer system in which the transfer is carried out at every specified quantity of data.

The CM 60 requests that the CM 90 acquire the second free space of the cache 93 used for the writing of the data 22 in accordance with the determined communication route (S33).

Upon reception of the acquisition request of the second free space, the CM 90 starts the acquisition of the second free space 98 (S34). With the processes described above, the acquisition process of the second free space 98 by the CM 60 and that of the first free space by the CM 90 are executed asynchronously.

Upon completing the acquisition of the first free space, the CM 60 transmits a notification to the host 41 that the acquisition of the first free space 68 has been completed. Upon reception of the notification of completion of the acquisition of the first free space 68, the host 41 transmits the data 22 to the CM 60 (S35). Upon receiving the data 22, the CM 60 writes the data 22 in the cache 63.

Upon completing the acquisition of the second free space 98, the CM 90 transmits a notification of completion of the acquisition of the second free space 98 to the CM 60. Upon reception of the notification of completion of the acquisition of the second free space 98, the CM 60 transmits specified data to the CM 90 when the specified data or greater of the data 22 is written in the cache 63. The CM 60 transmits repeatedly the specified data to the CM 90 and transmits the data 22 to the CM 90 (S36). By repeatedly receiving the specified quantity of data, the CM 90 then receives the data 22 from the CM 60. By repeatedly writing the received specified data from the CM 60 in the cache 98, the CM writes the data 22 in the cache 98. Note that the writing of the specified quantity of the data in the cache 98 by the CM 90 is started each time the specified data from the CM 60 is received.

Upon completing the transmission of the data 22 to the CM 90, the CM 60 transmits to the host 41 a writing response to a writing request from the host 41. Upon reception of the writing response from the CM 60, the host 41 may terminate communication with the CM 60.

Further, the CM 90 writes the data 22 written in the cache 93 in the storage device 102 (S37). Note that the CM may write the data 22 written in the cache 93 in the copy-destination storage device 102 at a specified timing. The CM 90 writes the data 22 written in the cache 93 in the copy-destination storage device 102 when the usage rate of the control circuit 91 is low.

As described above, the storage control apparatuses 1 and 2 of the embodiment start the acquisition of the second free space without waiting for the completion of the acquisition of the first free space 68. That is, the storage control apparatuses 1 and 2 asynchronously execute the acquisition process of the first free space and that of the second free space, so that the backup process time can be reduced. Further, the storage control apparatuses 1 and 2 of the embodiment carry out the transfer of the data 22 in a divided manner and make each data transfer process time shorter, so that the data 22 can be transferred more quickly than the package transfer. In addition, since the storage control apparatuses 1 and 2 of the embodiment divide the transfer of the data 22 and start the transfer of the specified quantity of data before the completion of writing the data 22 in the free space, the backup process time can be reduced.

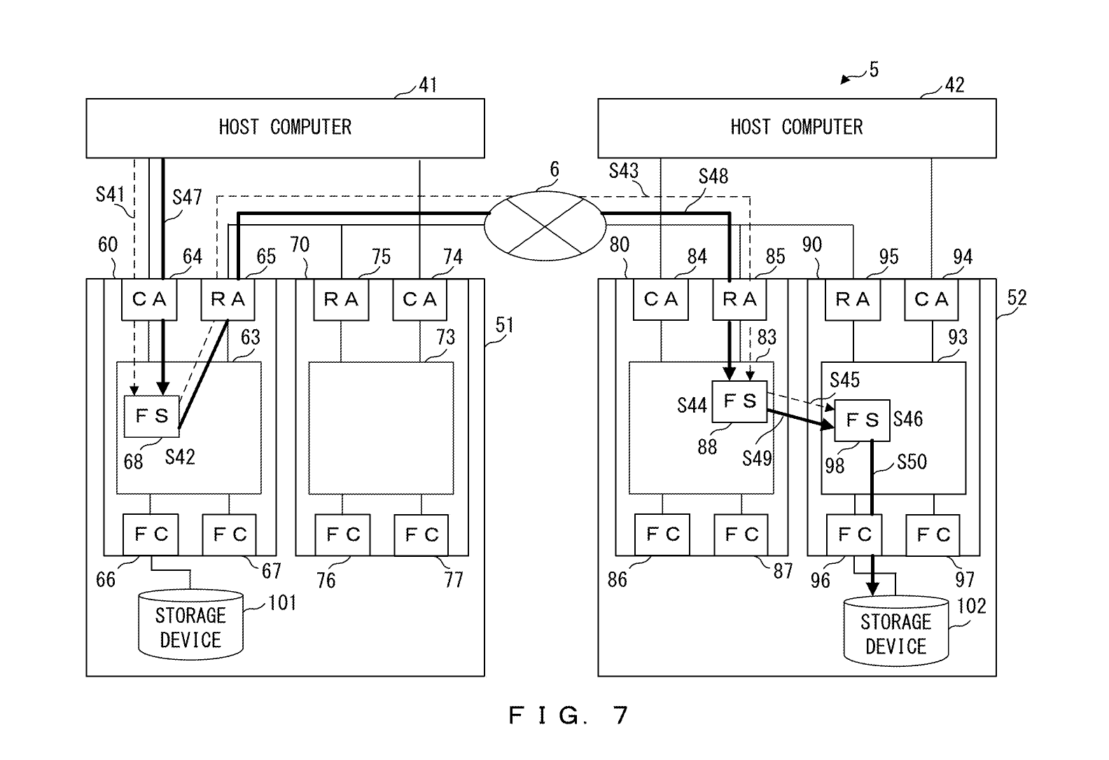

Descriptions will be given with reference to FIG. 7.

FIG. 7 illustrates a transfer process from the CM 60 to the CM 90 through the CM 80. A storage system 5 in FIG. 7 has the same structure as the storage system 5 in FIG. 2. In order to simplify the description, the illustration of a control circuit and a memory of each storage control system is omitted.

When writing the data 22 in a copy-source storage device 101, the host 41 transmits a writing request to the CM 60 connected to the storage device 101(S 41).

Upon reception of the writing request, the CM 60 starts the acquisition of the first free space 68 of the cache 63 used for writing the data 22 (S 42). Further, the CM 80 determines a communication route for the transfer of the data 22. In FIG. 7, descriptions will be given on the assumption that a communication route to transmit the data 22 from the CM 60 to the CM 90 through the CM 80 has been determined. Further, the CM 60 determines whether a response time is equal to or greater than the third threshold value with reference to the performance information 26. In FIG. 7, descriptions will be given on the assumption that the response time is less than the third threshold value. Thus, the CM determines that the data 22 be transferred by means of a package transfer system in which the data is transmitted through a one-time transfer process.

The CM 60 then requests that the CM 60 acquire the fourth free space of the cache 83 used for writing the data 22 in the CM 80 in accordance with the determined communication route (S43).

Upon reception of the acquisition request of the fourth free space 88, the CM 80 starts the acquisition of the fourth free space 88 (S44). With those processes described above, the acquisition process of the first free space 68 by the CM 60 and the acquisition process of the fourth free space 88 by the CM 80 are executed asynchronously.

The CM 80 requests that the CM 90 acquire the second free space 98 of the cache 93 used for writing the data 22 in the CM 90 in accordance with the determined communication route (S45).

Upon reception of the request for the acquisition of the second free space, the CM 90 starts the acquisition of the second free space (S46). With the descriptions above, the acquisition process of the first free space 68 by the CM 60 and that of the fourth free space 88 by the CM 80 are executed asynchronously.

Upon completion of the acquisition of the first free space, the CM 60 transmits a notification of completion of the acquisition of the first free space 68. Upon reception of the notification of completion of the acquisition of the first free space 68, the host 41 transmits the data 22 to the CM 60 (S47). Upon reception of the data 22, the CM 60 starts writing the data 22 in the cache 63.

Upon completing the acquisition of the fourth free space 88, the CM 80 transmits to the CM 60 a notification that the acquisition of the fourth free space 88 has been completed. Upon receiving the notification of completion of the acquisition of the fourth free space 88 and completing the writing of the data 22 in the cache 63, the CM 63 transmits the data 22 written in the cache 63 to the CM 80 (S48). Upon reception of the data 22, the CM 80 then starts writing the data 22 in the cache 83. Upon completing the transmission of the data 22 to the CM 80, the CM 60 transmits to the host 41 a writing response to a writing request from the host 41. Upon reception of the writing response from the CM 60, the host 41 may terminate the communication with the CM 60.

Upon completing the acquisition of the second free space 98, the CM 90 transmits to the CM 98 a notification to complete the acquisition of the second free space 98. Upon receiving the notification of completion of the acquisition of the second free space 98 and completing the writing of the data 22 in the cache 83, the CM 80 transmits the data written in the cache 83 to the CM 90 (S 49). Upon reception of the data 22, the CM 90 starts writing the data 22 in the cache 93.

Further, upon completing the writing of the data 22 in the cache 93, the CM 90 writes the data 22 written in the cache 93 in the storage device 192 (S50). Note that the CM may write the data 22 written in cache 93 in the copy-destination storage device 102 at a specified timing. The CM 90 may write the data 22 written in the cache 93, for example, in the copy-destination storage device 102 when the usage rate of the control circuit 91 is low.

As described above, since the storage control apparatus of embodiments 1, 2 and 4 can execute asynchronously the acquisition process of the first free space, the acquisition process of the second free space and the acquisition process of the fourth free space, the backup process time can be reduced.

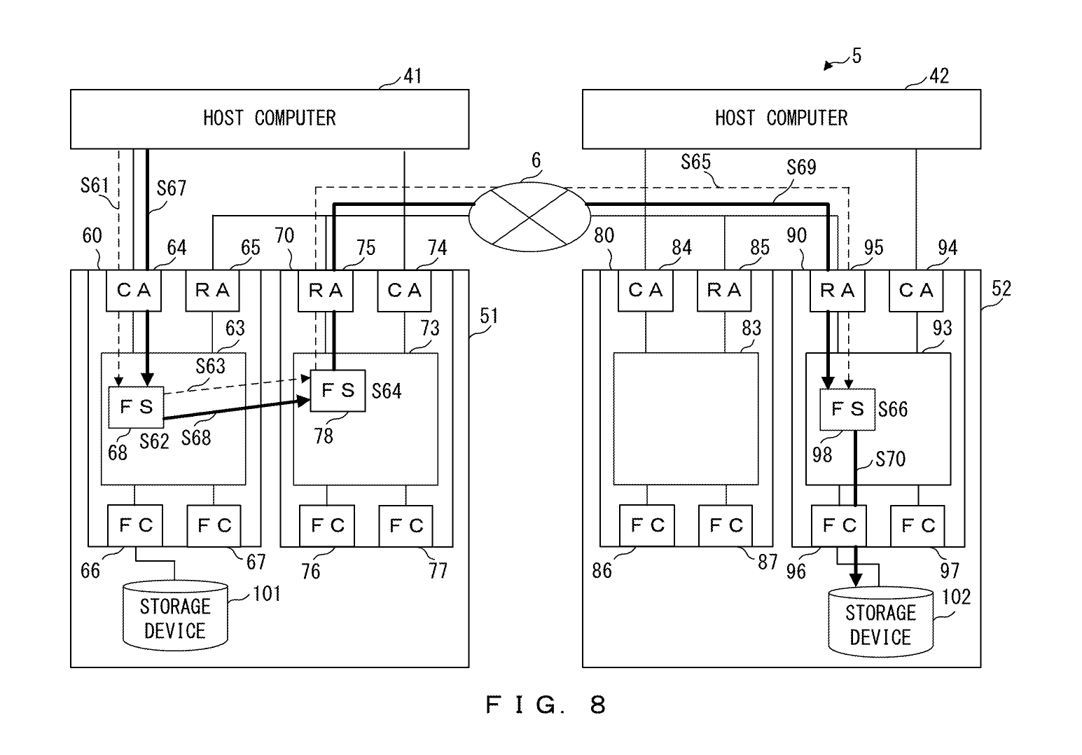

Descriptions will be given with reference to FIG. 8.

FIG. 8 illustrates a transfer process from the CM 60 to the CM 90 through the CM 70. A storage system 5 of FIG. 8 is the same in structure as the storage system 5 of FIG. 2. Further, in order to simplify the descriptions, a control circuit and a memory are omitted from each storage control apparatus.

When writing the data 22 in the copy-source storage device 101, the host 41 transmits a writing request to the CM 60 connected to the storage device 101 (S61).

Upon receiving the writing request, the CM 60 starts the acquisition of the first free space 68 of the cache 63 (S62). Further, the CM 60 determines a communication route to transfer the data 22. In FIG. 8, descriptions will be given on the assumption that the communication route is determined to be a route to transmit the data 22 from the CM 60 to the CM 90 through the CM 70. Further, the CM 60 determines whether a response time is equal to or greater than the third threshold value with reference to the performance information 26. In FIG. 8, descriptions will be given on the assumption that the response time is less than the third threshold value. Thus, the CM 60 determines that the data 22 be transferred by means of a package transfer system of a one-time transfer process.

The CM 60 then requests that the CM 70 acquire the third free space 78 of the cache 73 used for writing the data (S63).

Upon receiving the writing request for the acquisition of the third free space 78, the CM 70 starts the acquisition of the third free space 78 (S64). With the above descriptions, the acquisition process of the first free space 68 by the CM 60 and that of the second free space 78 by the CM 70 are executed asynchronously.

The CM 70 requests that the CM 90 acquire the second free space 98 of the cache 93 used for writing the data (S65).

Upon receiving the writing request for the acquisition of the third free space, the CM 60 starts the acquisition of the second free space 98 (S66). As described above, the acquisition process of the first free space 68 by the CM 60, the acquisition process of the third free space 78 by the CM 70, and the acquisition process of the second free space 98 by the CM 90 are executed asynchronously.

Upon completing the acquisition of the third free space 78, the CM 60 transmits to the host 41 a notification of completion of the acquisition of the first free space 68. Upon reception of the completion of the acquisition of the first free space 68, the host 41 transmits the data 22 to the CM 60 (S67). Upon receiving the data 22, the CM 60 starts writing the data 22 in the cache 63.

Upon completing the acquisition of the third free space, the CM 70 transmits to the CM 60 a notification of completion of the acquisition of the third free space 78. Upon receiving the notification of completion of the acquisition of the third free space and completing the writing of the data 22 in the cache 63, the CM 60 transmits the data 22 written in the cache 63 to the CM 70 (S68).

Upon reception of the data 22, the CM 70 starts writing the data 22 in the cache 63. Further, upon completing transmission of the data 22, the CM 60 transmits to the host 41 a writing response to a writing request from the host 41. Upon receiving the writing response from the CM 60, the host 41 may terminate communication with the CM 60.

Upon completing the acquisition of the second free space 98, the CM 90 transmits to the CM 70 a notification of completion of the acquisition of the second free space 98. Upon receiving the notification of completion of the acquisition of the second free space 98 and completing the writing of the data 22 in the cache 73, the CM 70 transmits the data 22 written in the cache 73 to the CM 90 (S69). Upon reception of the data 22, the CM 90 starts writing the data 22 in the cache 93.

Further, upon completing the writing of the data in the cache 93, the CM 90 writes the data written in the cache 93 in the storage device 102 (S70). Note that the CM 90 may write the data 22 written in the cache 93 in the copy-destination storage device 101 at a specified timing. The CM 90 may write the data 22 written in the cache 93, for example, in the copy-destination storage device 102 when the usage rate of the control circuit 91 is low.

As described above, since the storage control apparatus of embodiments 1, 2 and 3 can execute asynchronously the acquisition process of the first free space, the acquisition process of the second free space and the acquisition process of the third free space, the backup process time can be reduced.

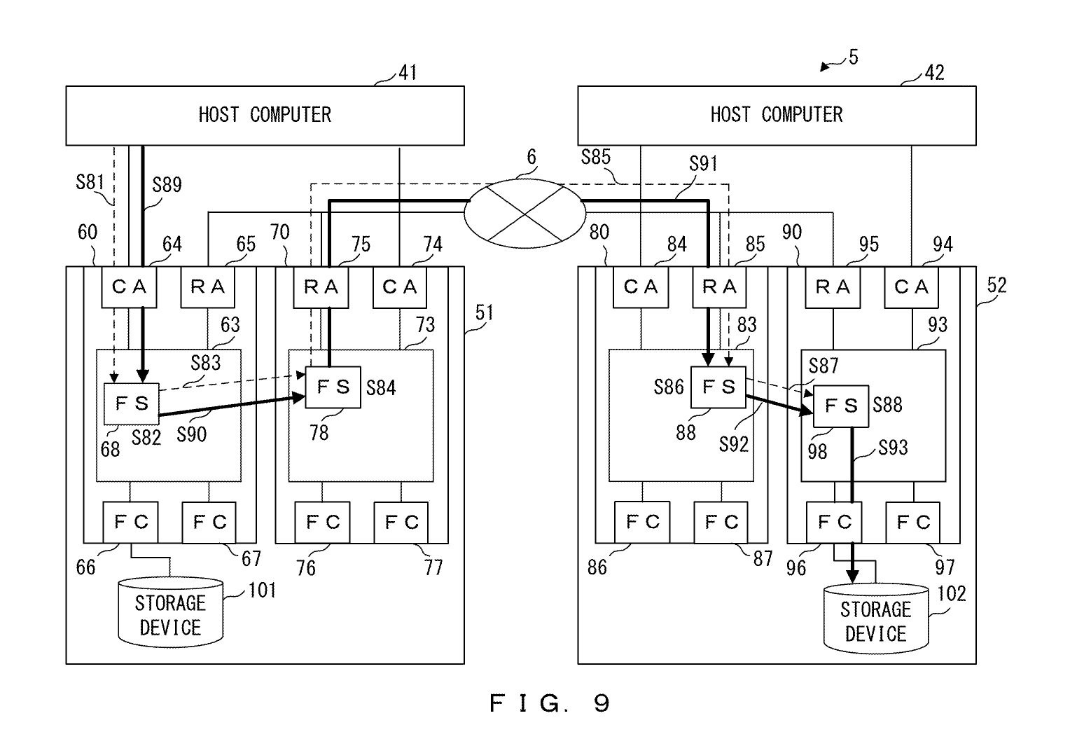

Descriptions will be given with reference to FIG. 9.

FIG. 9 illustrates a transfer process from the CM 60 to the CM 90 through the CM 70 and the CM 80. A storage system 5 of FIG. 9 has the same structure as the storage system 5 of FIG. 2. Further, in order to simplify the description, a control circuit and a memory are omitted from each storage control apparatus.

When writing the data 22 in the copy-source storage device 101, the host 41 transmits a writing request to the CM 60 connected to the storage device 101 (S 81).

Upon reception of the writing request, the CM 60 starts the acquisition of the first free space 68 of the cache 63 used for writing the data 22 (S82). Further, the CM 60 determines a communication route for transferring the data 22. In FIG. 9, descriptions will be given on the assumption that a communication route to transmit the data 22 from the CM 60 to the CM 90 through the CM 70 and the CM 80 has been determined. Further, the CM 60 determines whether a response time is equal to or greater than the third threshold value with reference to the performance information 26. In FIG. 9, descriptions will be given on the assumption that the response time is greater than the third threshold value. Thus, the CM 60 determines that the data 22 be transferred by means of a divisional transfer system to transfer the data 22 at every specified quantity of data.

The CM 60 then requests that the CM 70 acquire the third free space of the cache 73 used for writing the data 22 in the CM 70 in accordance with the communication route determined by the CM 60 (S83).

Upon reception of the acquisition request of the third free space 78, the CM 70 stars the acquisition of the third free space (S84). With those processes described above, the acquisition process of the first free space 68 by the CM 60 and the acquisition process of the third free space 78 by the CM 70 are executed asynchronously.

The CM 70 requests that the CM 80 acquire the fourth free space 88 of the cache 83 used for writing the data 22 in the CM 80 in accordance with the communication route decided by the CM 60 (S85).

Upon reception of the request for the acquisition of the fourth free space 88, the CM 80 starts the acquisition of the fourth free space (S86). With those processes described above, the acquisition processing processes of the first free space 68 by the CM 60, the third free space 78 by the CM 70, and the fourth free space 88 by the CM 80 are executed asynchronously.

The CM 80 then requests that the CM 90 acquire the second free space 98 of the cache 93 used for writing the data 22 in the CM 90 in accordance with the communication route determined by the CM 60 (S87).

Upon reception of the acquisition request of the second free space 98, the CM 90 starts the acquisition of the second free space 98 (S88). With those processes described above, the acquisition processes of the first free space 68 by the CM 60, the third free space 78 by the CM 70, the fourth free space 88 by the CM 80, and the second free space 98 by the CM 90 are executed asynchronously.

Upon completing the acquisition of the first free space 68, the CM 60 transmits to the host 41 a notification of completion of the acquisition of the first free space 68. Upon reception of the acquisition notification of the first free space 68, the host 41 transmits the data 22 to the CM (S89). Upon reception of the data 22, the CM 60 starts writing the data 22 in the cache 63.

Upon completing the acquisition of the third free space 78, the CM 70 transmits to the CM 60 a notification of completion of the acquisition of the third free space 78. Upon reception of the notification to complete the acquisition of the third free space 78, and when data that is equal to or greater than a specified quantity of data in the data 22 is written in the cache 63, the CM 60 transmits a specified quantity of data to the CM 70. The CM 60 repeatedly transmits the specified data to the CM 70 and transmits the data 22 to the CM 70 (S90). By repeatedly receiving the specified quantity of data, the CM 70 then receives the data 22 from the CM 60. By repeatedly writing the specified quantity of data 22 received from the CM 60 in the cache 73, the CM 70 writes the data 22 in the cache 98. Note that the writing of the specified quantity of the data in the cache 73 by the CM 70 is started each time the specified data is received from the CM 60. Further, upon completing the transmission of the data 22 to the CM 70, the CM 60 transmits to the host 41 a writing response to a writing request from the host 41. Upon reception of the writing response from the CM 60, the host 41 may terminate communication with the CM 60.

Upon completing the acquisition of the fourth free space 88, the CM 80 transmits to the CM 70 a notification of completion of the acquisition of the fourth free space 88. Upon reception of the notification to complete the acquisition of the fourth free space 88, and when data that is equal to or greater than a specified quantity of data in the data 22 is written in the cache 73, the CM 70 transmits a specified quantity of data to the CM 80. The CM 70 repeatedly transmits the specified data to the CM 80, and transmits the data 22 to the CM 80 (S91). By repeatedly receiving the specified quantity of data, the CM 80 then receives the data 22 from the CM 70. By repeatedly writing the specified quantity of data 22 received from the CM 70 in the cache 83, the CM 80 writes the data 22 in the cache 83. Writing the specified quantity of the data in the cache 83 by the CM 80 is started each time the specified data is received from the CM 70.

Upon completing the acquisition of the second free space 98, the CM 90 transmits to the CM 80 a notification of completion of the acquisition of the second free space 98. Upon reception of the notification of completion of the acquisition of the second free space 98, and when data that is equal to or greater than a specified quantity of data in the data 22 is written in the cache 83, the CM 80 transmits a specified quantity of data to the CM 90. The CM 80 repeatedly transmits the specified data to the CM 90, and transmits the data 22 to the CM 90 (S92). By repeatedly receiving the specified quantity of data, the CM 90 then receives the data 22 from the CM 80. By repeatedly writing the specified quantity of data 22 received from the CM 80 in the cache 93, the CM 90 writes the data 22 in the cache 93. Writing the specified quantity of the data in the cache 93 by the CM 90 is started each time the specified data is received from the CM 80.

Further, upon completing writing of the data 22 in the cache 93, the CM 90 writes the data 22 written in the cache 93 in the storage device 102 (S93). Note that the CM 90 may write the data 22 written in cache 93 in the copy-destination storage device 101 at a specified timing. The CM 90 may write the data 22 written in the cache 93, for example, in the copy-destination storage device 102 when the usage rate of the control circuit 91 is low.

As described above, since the storage control apparatuses 1 through 4 of the embodiment asynchronously execute the acquisition processes of the first free space, the second free space, the third free space, and the fourth free space, the backup process time can be reduced.

Further, the storage control apparatuses 1 through 4 of the embodiments carry out the divisional transfer of the data 22 and make each data transfer process time shorter, so that the data 22 can be transferred more quickly than a package transfer. In addition, since the storage control apparatuses 1 through 4 of the embodiments divide the transfer of the data 22 and start the transfer of a specified quantity of data before the completion of writing the data 22 in the free spaces, the backup process time can be reduced.

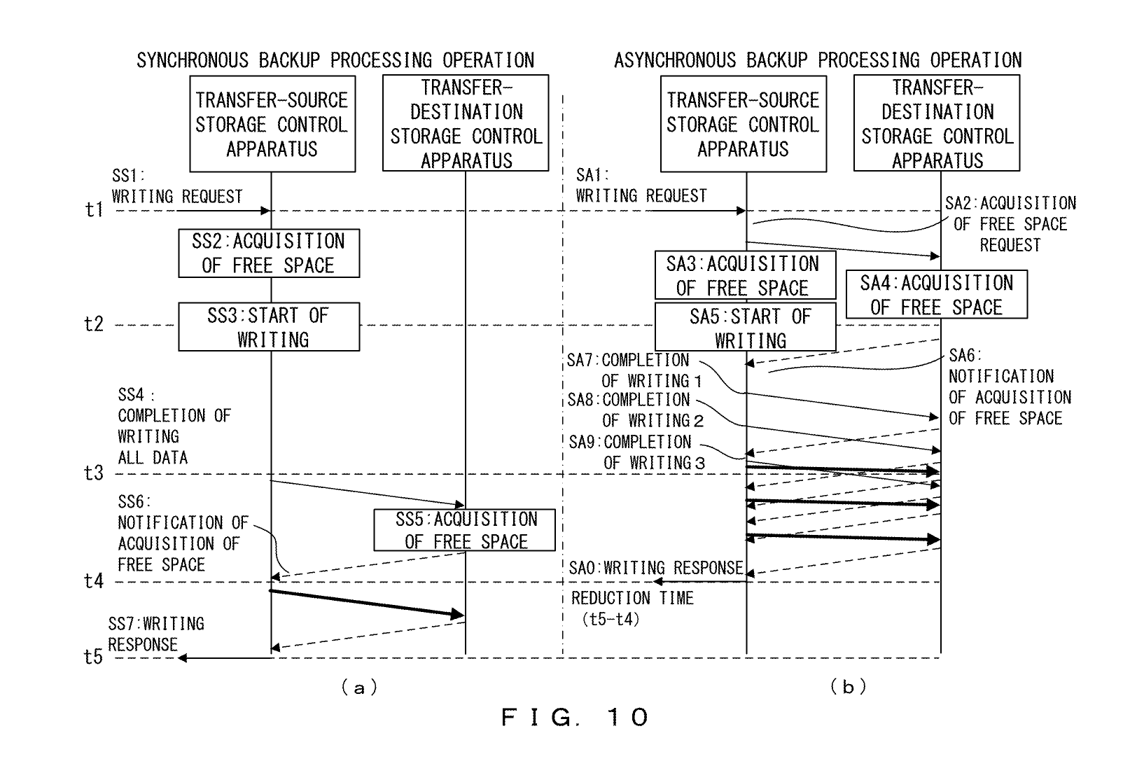

FIG. 10 is a diagram illustrating a difference in process time between a synchronous process and an asynchronous process.

FIG. 10 illustrates a backup process to transmit and receive the data 22 between the transfer-source storage control apparatus 1 and the transfer-destination storage control apparatus 2. FIG. 10(a) is a sequence diagram illustrating a synchronous backup process. FIG. 10(b) is a sequence diagram illustrating an asynchronous backup process.

A data transfer process in the synchronous backup process will be described with reference to FIGS. 2 and 10(a).

Upon receiving a request from the host 41 to write the data 22 at time t1 (SS1), the transfer-source storage control apparatus 1 starts the acquisition of the first free space 68 of the cache 63 (SS2).

Upon completing the acquisition of the first free space 68 at time t2, the transfer-source storage control apparatus 1 acquires the data 22 from the host 41 and starts writing the data 22 in the cache 63 (SS3).

Upon completing the writing of the data 22 in the cache 63 at time t3 (SS4), the transfer-source storage control apparatus 1 requests that the transfer-destination storage control apparatus 2 acquire the second free space 98. Upon reception of the acquisition request of the second free space 98, the transfer-destination storage control apparatus 2 starts the acquisition of the second free space 98. Upon completing the acquisition request of the second free space 98 (SS5), the transfer-destination storage control apparatus 2 then transmits to the transfer-source storage control apparatus 1 a notification of the completion of the acquisition of the second free space 98 (SS6).

Upon reception of the notification for the transfer-destination storage control apparatus 2 of the completion of the acquisition of the second free space 98, the transfer-source storage control apparatus 1 transmits the data 22 written in the cache 63 to the transfer-destination storage control apparatus 2. Upon receiving the data 22, the transfer-destination storage control apparatus 2 notifies the transfer-source storage control apparatus 1 of the completion of the reception of the data 22.

Upon receiving the notification to complete the receipt from the transfer-destination storage control apparatus 2 at time t5, the transfer-source storage control apparatus 1 transmits to the host 41 a writing response indicative of the completion of the writing process (SS7).

A data transfer process in the asynchronous backup process will be described with reference to FIGS. 2 and 10(b). The description will be given on the assumption that the asynchronous backup process transmits three pieces of specified data by means of a divisional transfer system.

Upon receiving a request from the host 41 to write the data 22 at time t1 (SA1), the transfer-source storage control apparatus 1 requests that the transfer-destination storage control apparatus 2 acquire the second free space 98 (SA2) and start the acquisition of the first free space 68 of the cache 63 (SA3).

Upon receiving the request to acquire the second free space 98, the transfer-destination storage control apparatus 2 starts the acquisition of the second free space (SA4).

Upon completing the acquisition of the first free space 68 at time t2, the transfer-source storage control apparatus 1 acquires the data 22 from the host 41 and starts writing the data 22 in the cache 63 (SA5).

Upon completing of the acquisition request of the second free space 98, the transfer-destination storage control apparatus 2 transmits to the transfer-source storage control apparatus 1 a notification of completion of the acquisition of the second free space 98 (SA6).

Upon reception of the notification of the acquisition of the second free space 98 and completing the writing of the data 22 in the cache 63, the transfer-source storage control apparatus 1 transmits a specified quantity of data 1 to the transfer-destination storage control apparatus 2 (SA7). Upon completing the writing of the data in the cache 63, the transfer-source storage control apparatus 1 transmits a specified quantity of data 2 to the transfer-destination storage control apparatus 2 (SA8). Further, upon completing the writing of the specified quantity of data 3 in the cache 63 at time t3, the transfer-source storage control apparatus 1 transmits a specified quantity of data 3 to the transfer-destination storage control apparatus 2 (SA9).

Upon receiving the data 22, the transfer-destination storage control apparatus 2 notifies the transfer-source storage control apparatus 1 of the completion of the receipt of the data 22.

Upon reception of the notification of the completion of the receipt from the transfer-destination storage control apparatus 2 at time t4, the transfer-source storage control apparatus 1 transmits to the host 41 a writing response indicative of the completion of the writing process (SA0).

As described above, the acquisition of the second free space 98 by the transfer-destination storage control apparatus 2 in the synchronous backup process is executed after the start of the writing of the data 22. In contrast, the acquisition of the second free space 98 by the transfer-destination storage control apparatus 2 in the asynchronous backup process is executed in asynchronization with other processes. With this, the transfer-destination storage control apparatus 2 in the asynchronous backup process completes the acquisition of the second free space 98 at the start of the writing of the data 22. Thus, the writing of the data 22 in the asynchronous backup process can start the writing of the data 22 at once.

Further, the transfer of the data 22 to the transfer-destination storage control apparatus 2 starts in the synchronous backup process after completing the writing of the data 22 in the cache 63 by the transfer-source storage control apparatus 1. In contrast, when a specified quantity of data is written in the cache 63 of the transfer-source storage control apparatus 1 in the asynchronous backup process, the transfer of data 22 to the transfer-destination storage control apparatus 2 starts for every specified quantity of data. Hence, the transfer of the data 22 can start in the asynchronous backup process without waiting for writing the data 22 in the cache 63 of the transfer-source storage control apparatus 1.

Further, a package transfer of the data 22 to the transfer-destination storage control apparatus 2 is carried out in the synchronous backup process after completing of the writing of the data 22 in the cache 63 by the transfer-source storage control apparatus 1. In contrast, when a specified quantity of data is written in the cache 63 of the transfer-source storage control apparatus 1 in the asynchronous backup process, the transfer of data 22 to the transfer-destination storage control apparatus 2 is carried out for every specified quantity of data. Hence, in the asynchronous backup process, the transfer of data can be multiplexed so that a specified piece of data can be transmitted from the transfer-source storage control apparatus 1 to the transfer-destination storage control apparatus 2.

As described above, according to the asynchronous backup process, the acquisition of a free space and the transfer process of data are performed to be asynchronous, so that a process time can be reduced by a reduction time (t5−t4) illustrated in FIG. 10, for example, in comparison with the synchronous backup process.

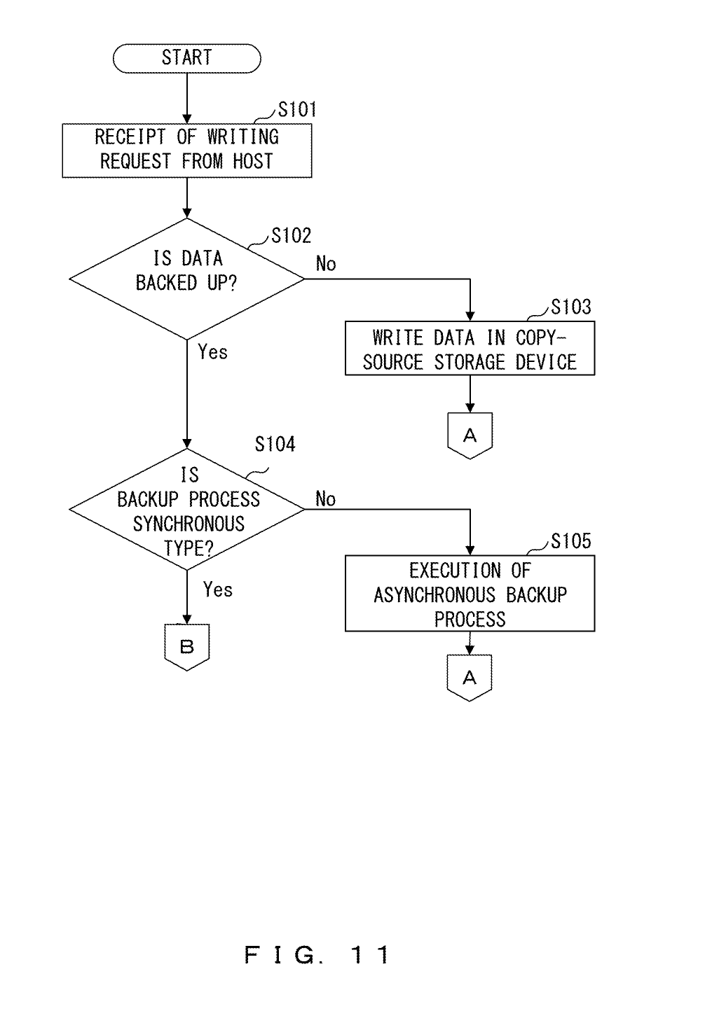

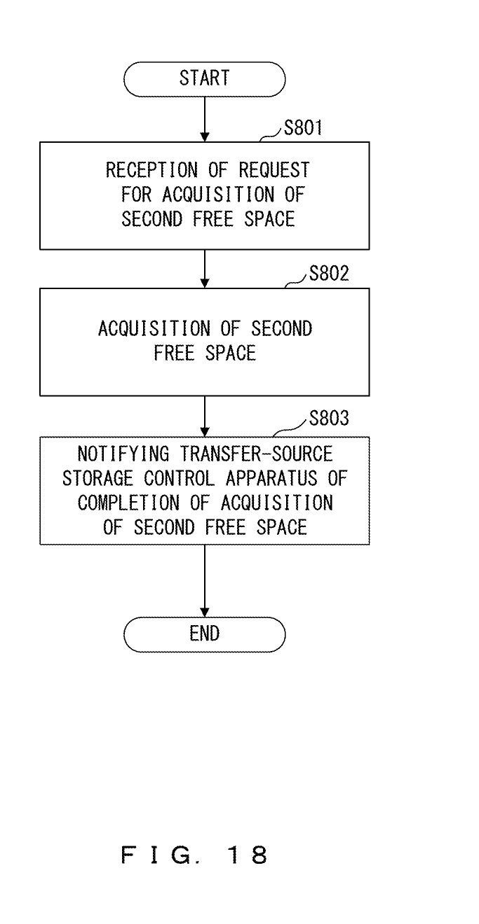

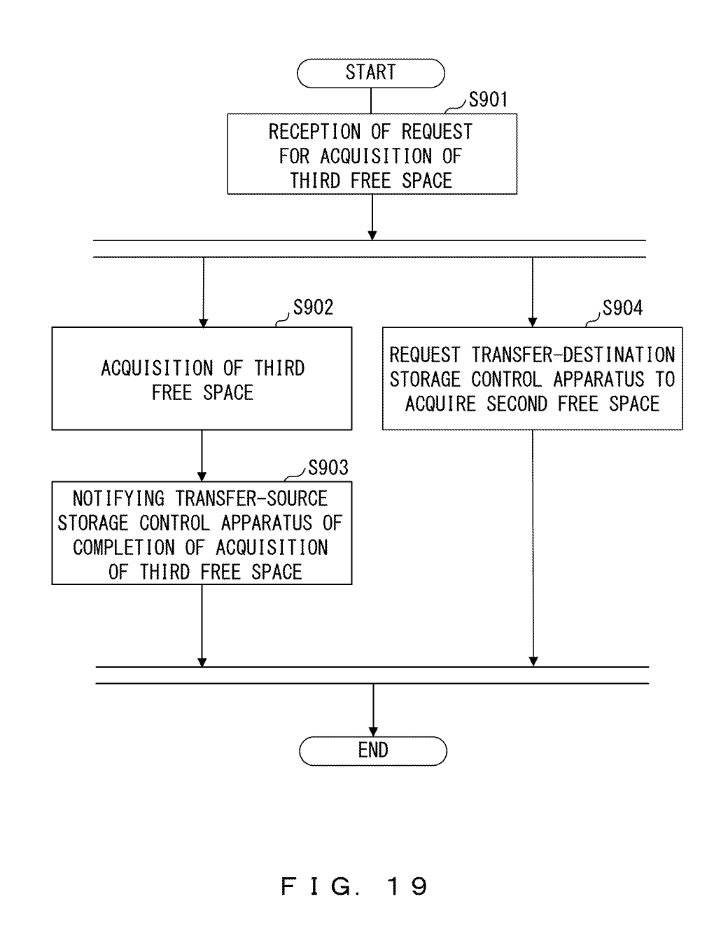

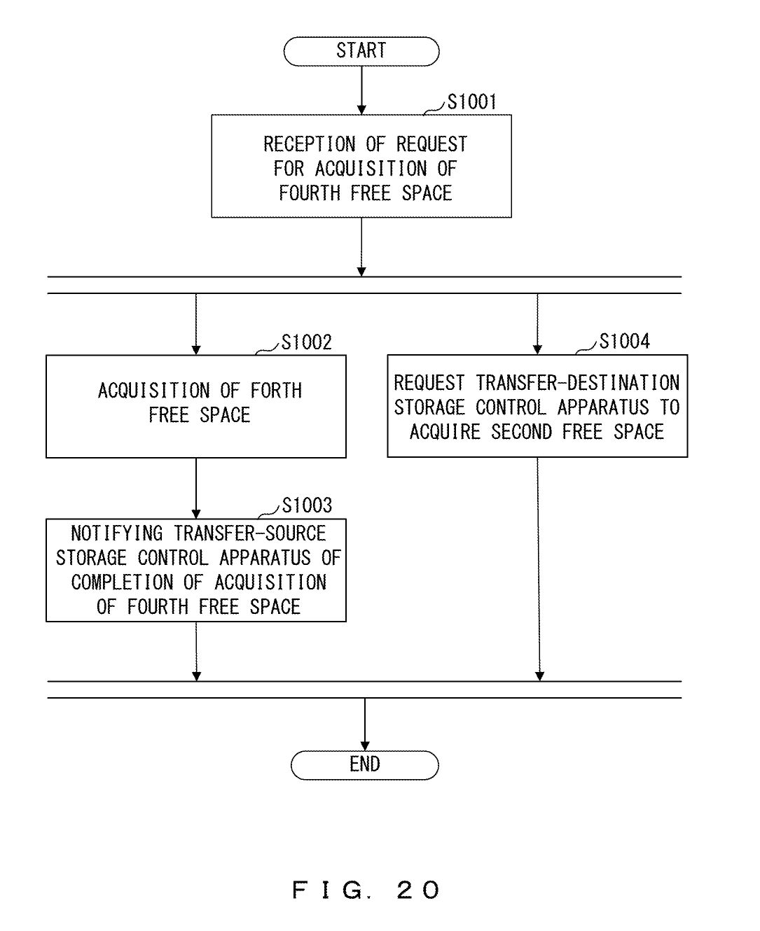

FIGS. 11 through 17 are flowcharts illustrating processes of a transfer-source storage control apparatus. FIG. 18 is a flowchart illustrating a free-space acquisition process of a transfer-destination storage control apparatus. FIGS. 19 and 20 are flowcharts illustrating free-space acquisition processes of a relay-destination storage control apparatus.

Backup processes executed by an embodiment of a storage control apparatus will be described with reference to FIG. 1 and FIGS. 11 through 20.

Descriptions will be given with reference to FIG. 11.

The transfer-source storage control apparatus 1 receives a request for the writing of the data 22 from a host (S101). Here, it is assumed that the writing request is provided with implementation information indicating whether the data 22 is to be backed up or not and category information indicating that either a synchronous type or an asynchronous type backup process is to be carried out. The asynchronous type backup process means the one using a stack transfer or a consistency transfer, for example.

The transfer-source storage control apparatus 1 determines whether or not the data 22 is to be backed up with reference to the implementation information provided to the received data 22 (S102).

When the data 22 is not backed-up data (S102: No), the transfer-source storage control apparatus 1 writes the data 22 in the copy-source storage device (S103). The transfer-source storage control apparatus 1 then terminates the process.

When the data 22 is backed-up data (S102: Yes), the transfer-source storage control apparatus 1 determines whether the backup process for the data 22 is the synchronous type or the asynchronous type (S104), referring to category information added to the data 22.

When the backup process for the data 22 is the asynchronous type (No in S104), the storage control apparatus 1 executes a specified asynchronous type backup process (S105). The storage control apparatus 1 then terminates the process.

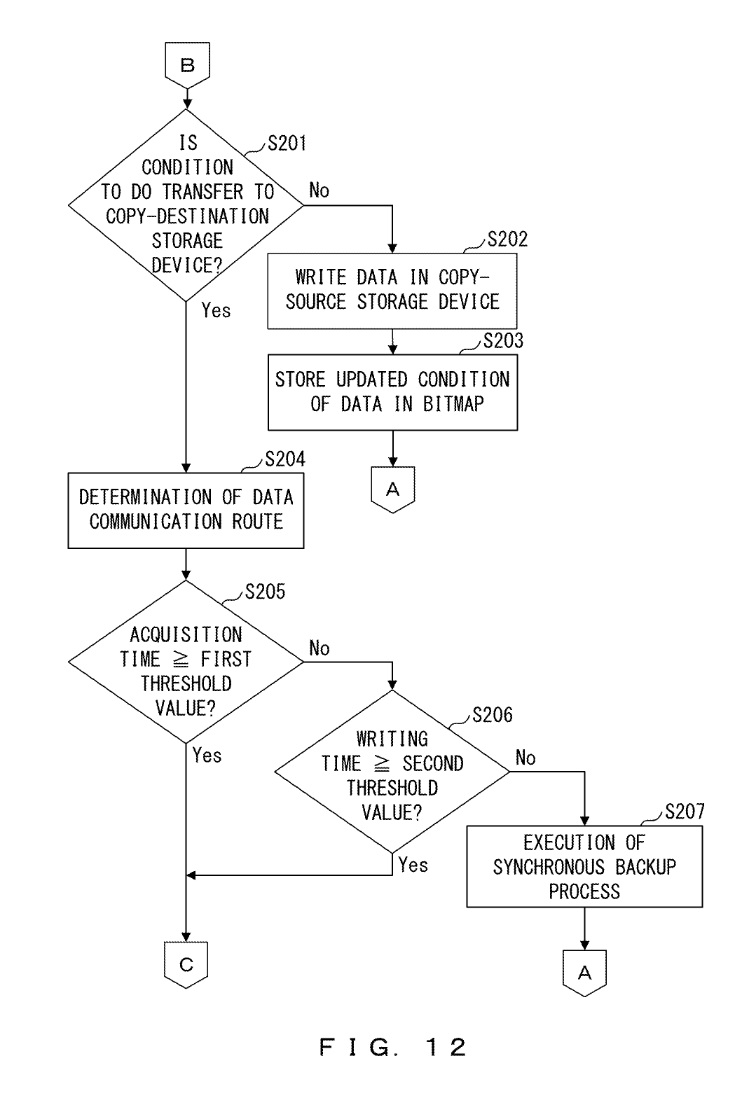

Descriptions will be given with reference to FIG. 12.

When the backup process for the data 22 is the synchronous type (Yes in S104), the storage control apparatus 1 determines whether a condition permits carrying out a transfer to a copy-destination storage device (S201).

When the condition does not permit carrying out a transfer to a copy-destination storage device (No in S201), the storage control apparatus 1 writes data received from a host in a copy-source storage device (S202).

The storage control apparatus 1 then stores in a bitmap that the data is stored in the copy-source storage device (S203). The storage control apparatus 1 then terminates the process. Note that the conditions of no transfer to a copy-destination storage device mean that the copy-destination storage device is out of order, a communication route between the transfer-source storage control apparatus 1 and the transfer-destination storage control apparatus 2 is out of order, an operator has performed setting-up to stop a backup data transfer, etc. Further, the storage control apparatus 1 may be notified of those conditions and those conditions may be recognized in the storage control apparatus 1.

If accessible to the copy-destination storage device (Yes in S201), the storage control apparatus 1 determines a communication route (S204). When the storage control apparatus 1 determines a communication route, each storage control apparatus on the communication route will be notified of the determined communication route. The following descriptions will be given on the assumption that, unless otherwise specified, the storage control apparatus 1 has selected a direct communication route with the storage control apparatus 2.

The storage control apparatus 1 determines whether an acquisition time of the first free space calculated up to the previous process is equal to or greater than the first threshold value with reference to the performance information 26 (S205).

When the acquisition time of the first free space is less than the first threshold value (No in S205), the storage control apparatus 1 determines whether a writing time calculated up to the previous process is equal to or greater than the second threshold value with reference to the performance information 26 (S206).

When the writing time is less than the second threshold value (No in S206), the storage control apparatus 1 executes the synchronous backup process (S207).

When the acquisition time of the first free space is equal to or greater than the first threshold value (Yes in S205), the storage control apparatus 1 determines that the asynchronous backup process be executed and executes process S301. Further, when the writing time is equal to or greater than the second threshold value (Yes in S206), the storage control apparatus 1 determines that the asynchronous backup process be executed and executes the process S301.

In the process in and after S301, data transfers indicative of S401 through 406, S501, and S601 through S606, and processes for the acquisition of free spaces indicative of S701 through S703 are executed asynchronously.

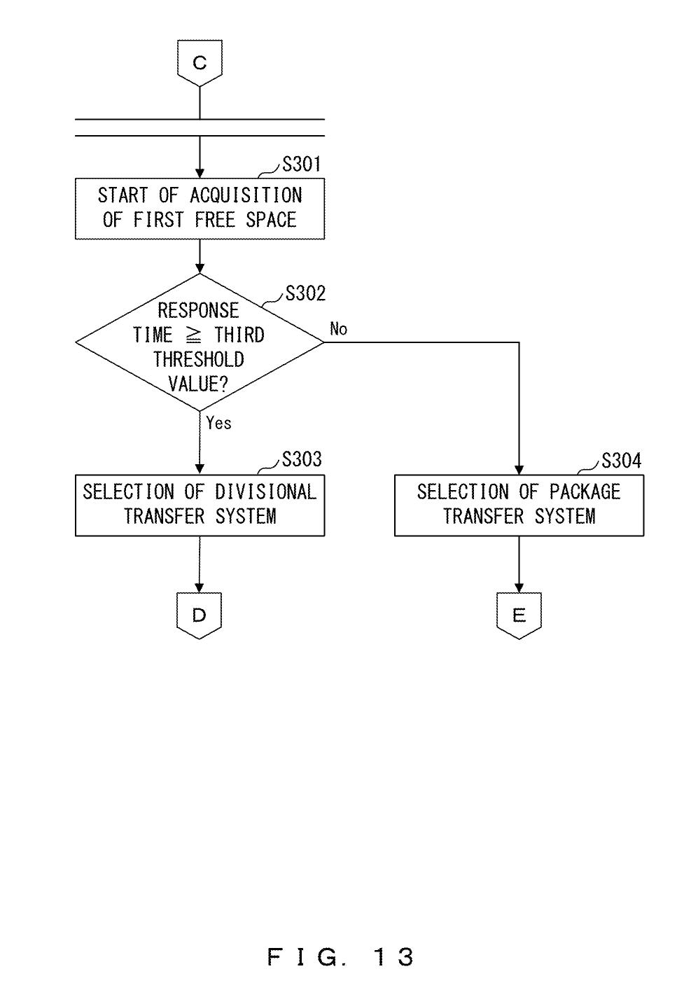

Descriptions will be given with reference to FIG. 13.

The storage control apparatus 1 starts the acquisition of the first free space (S301).

The storage control apparatus 1 determines whether a response time is equal to or greater than the third threshold value with reference to the performance information 26 (S302).

When the response time is equal to or greater than the third threshold value (Yes in S302), the storage control apparatus 1 selects the divisional transfer system (S303). The storage control apparatus 1 then executes the process S401.

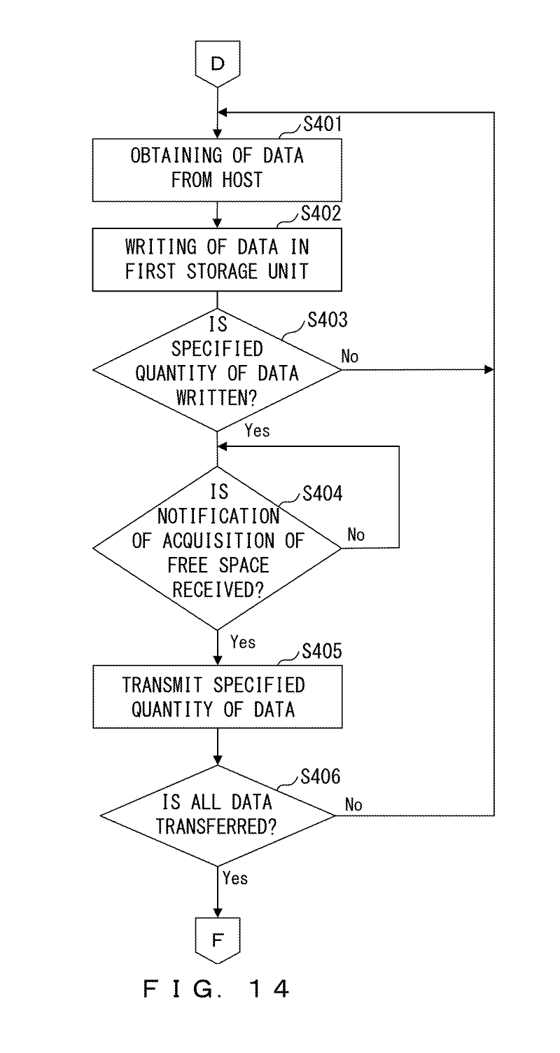

Descriptions will be given with reference to FIG. 14.

Upon completing the acquisition of the first free space, the storage control apparatus 1 acquires the data 22 from a host (S401). In the case in which there is no available data to be acquired from the host, the storage control apparatus 1 may omit the process S401 and execute the process 402 in the processes following the process S403.

At this time, if a size for storing a specified quantity of data is available, the storage control apparatus 1 may accept acquiring of the first free space that is smaller in size than the data 22. Thus, the storage control apparatus 1 can reduce the acquisition time of the first free space. When the divisional transfer system is used, a size of the first free space may be set to appropriately increase a transfer speed of the data 22.

The storage control apparatus 1 then writes the acquired data 22 in the first storage unit (S402).

The storage control apparatus 1 determines whether a specified quantity of data is stored in the first storage unit (S403).

When the specified quantity of data is not written in the first storage unit (S403), the storage control apparatus 1 executes the process S401.

When the specified quantity of data is written in the first storage unit (Yes in S403), the storage control apparatus 1 determines whether a notification of completion of the acquisition of the second free space from the transfer-destination storage control apparatus 2 has been received (S404). The storage control apparatus 1 repeats the process S404 (No in S404) until a notification of completion of the acquisition of the second free space from the transfer-destination storage control apparatus 2 is received.

Upon receiving the notification of completion of the acquisition of the second free space from the transfer-destination storage control apparatus 2 (Yes in S404), the storage control apparatus 1 transmits a specified quantity of data to the transfer-destination storage control apparatus 2 (S405).

When the specified quantity of data is transmitted to the transfer-destination storage device 2, the storage control apparatus 1 determines whether all of the data is transmitted to the transfer-destination storage device 2 (S406). When the specified quantity of data is not transmitted to the transfer-destination storage device 2 (No in S406), the storage control apparatus 1 executes the process 5401.

Transferring all of the data 22 (Yes in S406), the storage control apparatus 1 executes the process S501.

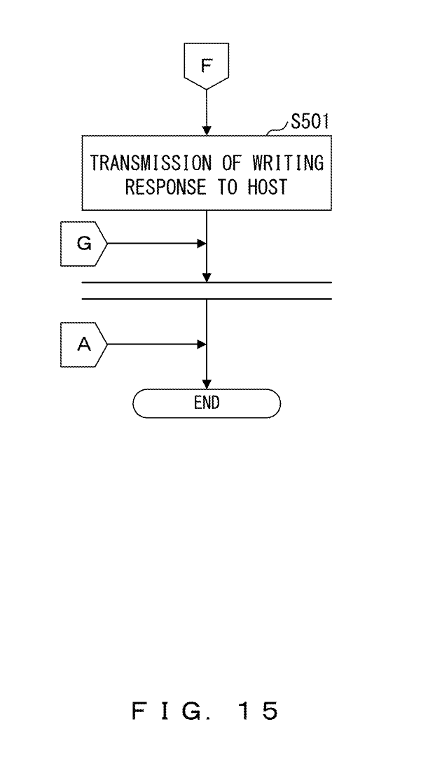

Descriptions will be given with reference to FIG. 15.

The storage control apparatus 1 transmits a writing response to a host (S501). The storage control apparatus 1 then terminates the process.

Descriptions will be given with reference to FIG. 13.

When a response time is less than the third threshold value (No in S302), the storage control apparatus 1 selects a package transfer system (S304). The storage control apparatus 1 then executes the process S601.

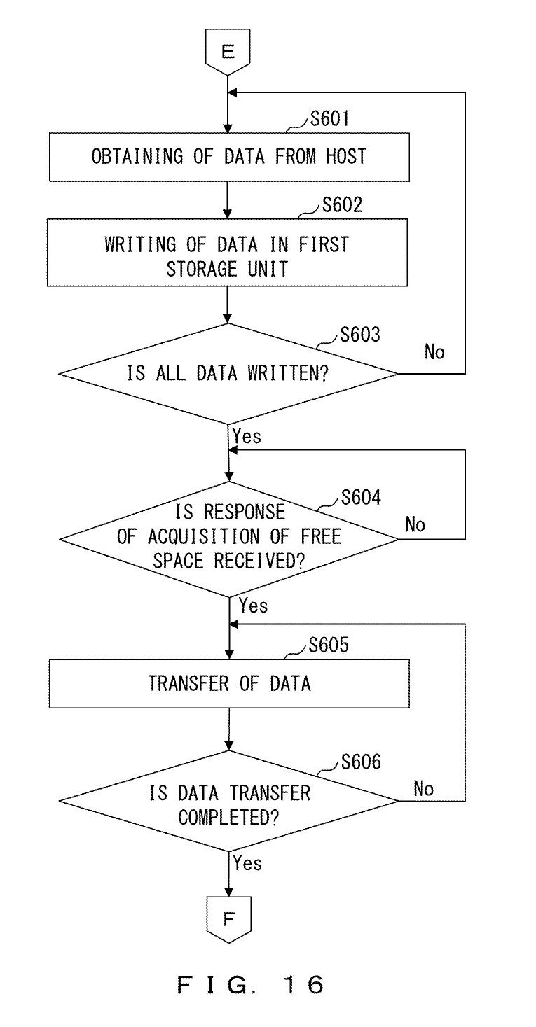

Descriptions will be given with reference to FIG. 16.

The storage control apparatus 1 acquires the data 22 from a host (S601). Note that, in the case when no data is acquired from the host in S601, the storage control apparatus 1 may omit S601 and execute the process S602 in the processes following the process S603.

The storage control apparatus 1 then writes the acquired data 22 in the first storage unit (S602).

The storage control apparatus 1 determines whether the data 22 is written in the first storage unit (S603).

When the data 22 is not written in the first storage unit (No in S603), the storage control apparatus 1 executes the process S601.

When the data 22 is written in the first storage unit (Yes in S403), the storage control apparatus 1 determines whether a notification of completion of the acquisition of the second free space from the transfer-destination storage control apparatus 2 has been received (S604). The storage control apparatus 1 repeats the process S604 (No in S604) until a notification of completion of the acquisition of the second free space is received from the transfer-destination storage control apparatus 2.

Upon receiving the notification of completion of the acquisition of the second free space from the transfer-destination storage control apparatus 2 (Yes in S604), the storage control apparatus 1 transmits the data 22 to the transfer-destination storage device 2 (S605).

The storage control apparatus 1 determines whether the transfer of the data 22 (S606) has been completed. When the transfer of the data 22 (S606) has not been completed, the storage control apparatus 1 executes the process S605.

Upon completing the transfer of the data 22 (Yes in S606), the storage control apparatus 1 executes the processes illustrated in FIG. 15. The storage control apparatus 1 then terminates the process.

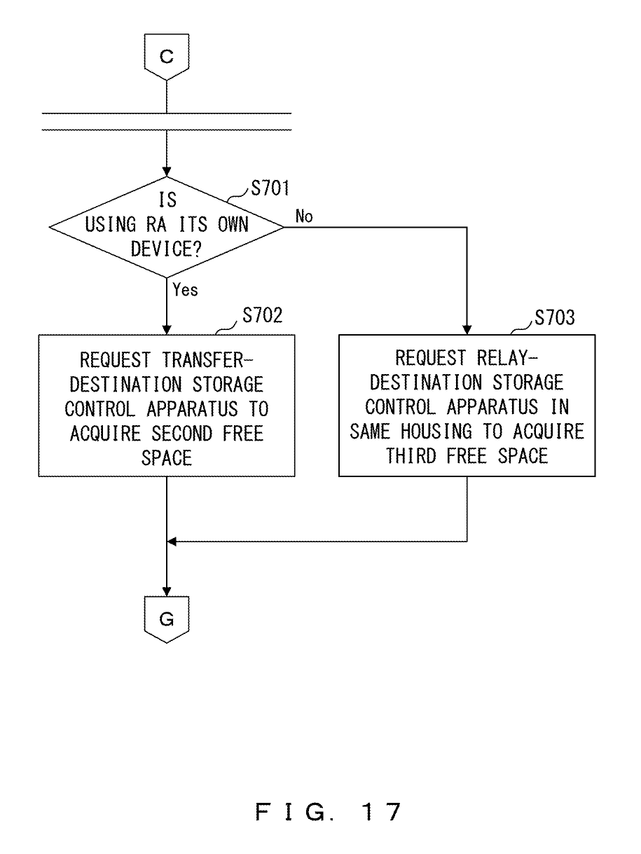

Descriptions will be given with reference to FIG. 17.

Processes S701 through 703 are executed in asynchronization with the processes S401 through 406, S501, and S601 through 606.

The storage control apparatus 1 determines whether the RA is intended to be used by its own device (S701). When the RA is intended to be used by its own device (Yes in S701), the storage control apparatus 1 determines that a request that the transfer-destination storage control apparatus 2 acquire the second free space (S702) be performed. The storage control apparatus 1 then terminates the process.

When the RA is not intended to be used by its own device (No in S701), the storage control apparatus 1 requests that the relay-destination storage control apparatus 3 acquire the third free space (S703). The case when the RA is not intended to be used by its own device is the case when a communication route with the transfer-destination storage control apparatus 2 through the relay-destination storage control apparatus 3 is determined. The storage control apparatus 1 then terminates the process.

Descriptions will be given with reference to FIG. 18.

The descriptions below are given on the assumption that the transfer-source storage control apparatus 1 has requested that the transfer-destination storage control apparatus 2 acquire the second free space. The descriptions will be further given on the assumption that the storage control apparatus 2 has been notified of a direct communication route with the storage control apparatus 1.

The storage control apparatus 2 receives the request for the acquisition of the second free space from the storage control apparatus 1 (S801).

The storage control apparatus 2 starts the acquisition of the second free space (S802).

Upon completing acquiring of the second free space, the storage control apparatus 2 notifies the storage control apparatus 1 of the completion of the acquisition of the second free space (S803).

The storage control apparatus 2 then terminates the acquisition of the second free space.

A process will be described when the acquisition of a free space is received from the relay-destination storage control apparatus 3.

Upon receiving a request for the acquisition of the second free space from the relay-destination storage control apparatus 3, for example, the storage control apparatus 2 executes the processes S801 and S802. The storage control apparatus 2 notifies the relay-destination storage control apparatus 3 of the completion of the acquisition of the second free space.

A process will be described when a request for the acquisition of a free space is received from the relay-destination storage control apparatus 4.

Upon receiving a request for the acquisition of the second free space from the relay-destination storage control apparatus 4, for example, the storage control apparatus 2 executes S801 and S802. In S803, the storage control apparatus 2 notifies the relay-destination storage control apparatus 4 of the completion of the acquisition of the second free space.

Descriptions will be given with reference to FIG. 19.

The descriptions below will be given on the assumption that the transfer-source storage control apparatus 1 has transmitted a request for acquisition of the third free space to the relay-destination storage control apparatus 3 in the process S703 of FIG. 17. The descriptions will be further given on the assumption that the storage control apparatus 3 has been notified of a direct communication route between the storage control apparatus 1 and the storage control apparatus 2 through the storage control apparatus 3. The storage control apparatus 3 asynchronously executes the processes of S902 and S903 and the process S904.

The storage control apparatus 3 receives the request for the acquisition of the third free space from the storage control apparatus 1 (S901).

The storage control apparatus 3 starts the acquisition of the third free space (S902).

Upon completing the acquisition of the third free space, the storage control apparatus 3 notifies the storage control apparatus 1 of the completion of the acquisition of the third free space (S903).

The storage control apparatus 3 requests that the storage control apparatus 2 acquire the second free space (S904).

The storage control apparatus 3 then terminates the acquisition of the free space.

Processes will be performed on the assumption that the storage control apparatus 3 has been notified of a communication route between the storage control apparatus 1 and the storage control apparatus 2 through the storage control apparatus 3 and the storage control apparatus 4.

Upon receiving a request for the acquisition of the third free space from the storage control apparatus 1, for example, the storage control apparatus 3 executes S901 through S903. In S904, the storage control apparatus 3 requests that the storage control apparatus 4 acquire the fourth free space in S904.

Descriptions will be given with reference to FIG. 20.

The descriptions below will be given on the assumption that the transfer-source storage control apparatus 1 has transmitted a request for acquisition of the fourth free space to the relay-destination storage control apparatus 4 in S703 of FIG. 17. The descriptions will be further given on the assumption that the storage control apparatus 3 has been notified of a communication route between the storage control apparatus 1 and the storage control apparatus 2 through the storage control apparatus 4. The storage control apparatus 3 asynchronously executes the processes S1002 and S1003 and the process S1004.

The storage control apparatus 4 receives the request for the acquisition of the fourth free space from the storage control apparatus 1 (S1001).

The storage control apparatus 4 starts the acquisition of the fourth free space (S1002).

Upon completing the acquisition of the fourth free space, the storage control apparatus 4 notifies the storage control apparatus 1 of the completion of the acquisition of the fourth free space (S1003).

The storage control apparatus 4 requests that the storage control apparatus 2 acquire the second free space (S1004).

The storage control apparatus 4 terminates the process for the acquisition of the free space.

Processes will be performed on the assumption that the storage control apparatus 4 has been notified of a communication route between the storage control apparatus 1 and the storage control apparatus 2 through the storage control apparatus 3 and the storage control apparatus 4.

Upon receiving a request for the acquisition of the fourth free space from the transfer-destination storage control apparatus 3, for example, the storage control apparatus 3 executes S1001 through S1002. In S1003, the storage control apparatus 3 notifies the storage control apparatus 3 of the completion of the acquisition of the fourth free space in S1003.

As described above, the storage control apparatus 1 of the embodiment requests that the transfer-destination storage control apparatus 2 acquire the second free space used for writing data before writing data by the writing unit 13 has been completed. With this, the storage control apparatus 1 asynchronously executes the process for the acquisition of the first free space with the process by the storage control apparatus 2 for the acquisition of the second free space, thereby making it possible to reduce the backup process time.

The storage control apparatus 1 of the embodiments divisionally transfers the data 22 to make the data transfer process time shorter so that the divisional data transfer takes a shorter time than a package data transfer. Hence, the storage control apparatus 1 of the embodiments can reduce the backup process time.

The storage control apparatus 1 of the embodiments divides the data 22 and makes the data transfer multiplexed, and transfers the data 22 in a shorter time than a package data transfer. Hence, the storage control apparatus 1 of the embodiments can reduce the backup process time.

The storage control apparatus 1 of the embodiment divides and transfers the data 22 to start the transfer of a specified quantity of data before a cache has completed writing the data 22. With this, the storage control apparatus 1 of the embodiments can reduce the backup process time.

Since the embodiments of the storage control apparatuses 1 through 4 asynchronously execute the process for the acquisition of the first free space, the process for the acquisition of the second free space, the process for the acquisition of the third free space, and the process for the acquisition of the fourth free space, the backup process time can be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage control apparatus comprising:
a first storage unit that stores data to be written data in a first storage device; and
a processor which executes a process, wherein
the process includes:
acquiring a first free space used for writing the data when a request to write data in the first storage unit is given,
writing the data in the first storage unit,
requesting that a transfer-destination storage control apparatus acquire a second free space used for writing the data before writing the data in the first storage unit in the writing process has been completed, the transfer-destination storage control apparatus being provided with a second storage unit for storing data to be written in a second storage device, and
transferring the data written in the first storage unit to the transfer-destination storage control apparatus.

2. The storage control apparatus of claim 1, wherein
the transferring process executed by the processor further including
transferring a data of specified quantity to the transfer-destination storage control apparatus when the data of specified quantity among all data written in the first storage device is written in the first storage device in the writing process.

3. The storage control apparatus of claim 1, wherein
the requesting process executed by the processor further including
requesting that the transfer-destination storage control apparatus acquire the second free space before the writing of the data in the first storage unit in the writing process when a period of time from when a request for the writing of the data is given until the first free space is acquired is equal to or greater than a first threshold value.

4. The storage control apparatus of claim 1, wherein
the requesting process executed by the processor further including
requesting that the transfer-destination storage control apparatus acquire the second free space before the writing of the data in the first storage unit has been completed in the writing process when a period of time from when the first free space is acquired until the writing of all the data to be written in the first storage device in the first storage unit is completed is equal to or greater than a second threshold value.

5. The storage control apparatus of claim 2, wherein the transferring process executed by the processor further including
transferring a data of specified quantity to the transfer-destination storage control apparatus when the data of specified quantity or greater is written in the first free space and when a time from when a request for the writing of the data is given until the transferring of all the data to be written in the first storage device to the transfer-destination storage control apparatus is completed is equal to or greater than a third threshold value.

6. The storage control apparatus of claim 2, wherein
the transferring process executed by the processor further including
transferring a data of specified quantity to the transfer-destination storage control apparatus after acquiring the first free space when the data of specified quantity or greater is written in the first free space and when a time from when a request for the writing of the data is given until the writing of all the data to be written in the first storage device is completed in the first storage unit is equal to or greater than a fourth threshold value.

7. The storage control apparatus of claim 1, wherein
the requesting process executed by the processor further including
requesting that the transfer-destination storage control apparatus acquire the second free space before the writing of the data in the first storage unit is completed in the writing process and when a time from when a request for the writing of the data is given until the writing of all the data to be written in the first storage device is completed is equal to or greater than a fifth threshold value.

8. The storage control apparatus of claim 2, wherein
the transferring process executed by the processor further including
transferring a specified quantity of data to the transfer-destination storage control apparatus when the specified quantity of data or greater is written in the first free space in the writing process and when a time from when the writing of all the data to be written in the first free space is completed until the transferring of all the data to be written in the first storage device to the transfer-destination storage control apparatus is completed is equal to or greater than a sixth threshold value.

9. A storage system comprising:
a transfer-source storage control apparatus; and
a transfer-destination storage control apparatus, wherein
the transfer-source storage control apparatus includes
a first storage unit that stores data to be written data in a first storage device, and
a first processor which executes a process including
acquiring a first free space used for writing the data when a request to write data in the first storage unit is given,
writing the data in the first storage unit,
requesting that a transfer-destination storage control apparatus acquire a second free space used for writing the data before writing the data in the first storage unit in the writing process has been completed, the transfer-destination storage control apparatus being provided with a second storage unit for storing data to be written in a second storage device, and
transferring the data written in the first storage unit to the transfer-destination storage control apparatus, and wherein
the transfer-destination storage control apparatus includes
a second processor which executes a process including
acquiring a second free space when the transfer-destination storage control apparatus receives a request to acquire the second free space.

10. The storage system of claim 9, further comprising:
a first relay-destination storage control apparatus;
wherein in the transfer-destination storage control apparatus, the process executed by the first processor further including
determining a communication route for transferring the data, and
notifying storage control apparatuses of the communication route determined by the determining process, the storage control apparatuses being on the communication route,
wherein the requesting process executed by the processor further including
requesting that the first relay-destination storage control apparatus acquire a third free space used for writing the data before writing the data in the first storage unit in the writing process when the communication route for transferring data to the transfer-destination storage control apparatus through the first relay-destination storage control unit in the determining process executed by the first processor is determined, the relay-destination storage control apparatus being provided with a third storage unit for storing relay data, and
wherein the first relay-destination storage control apparatus including
a third processor which executes a process including
acquiring the third free space when the first relay-destination storage control apparatus receives a request to acquire the third free space, and
requesting that the transfer-destination storage control apparatus acquire the second free space with reference to the communication route reported by the source-destination storage control apparatus before acquiring of the third free space in the acquiring process is completed.

11. The storage system of claim 10, further comprising:
a second relay-destination storage control apparatus;
wherein in the first relay-destination storage control apparatus, the requesting process executed by the third processor further including
requesting that the second relay-destination storage control apparatus acquire a fourth free space used for writing the data before acquiring of the third free space is completed when the communication route for transferring data to the transfer-destination storage control apparatus through the first relay-destination storage control apparatus and the second relay-destination storage control unit in the determining process executed by the first processor is determined, the second transfer-destination storage control apparatus being provided with a fourth storage unit for storing relay data, and
wherein the second relay-destination storage control apparatus including
a fourth processor which executes a process including
acquiring the fourth free space when the second relay-destination storage control apparatus receives a request to acquire the fourth free space, and
requesting that the transfer-destination storage control apparatus acquire the second free space with reference to the communication route reported by the source-destination storage control apparatus before acquiring of the fourth free space in the acquiring process is completed.

12. A non-transitory computer-readable recording medium therein a storage control program for causing a computer to execute a storage control process for controlling a storage control apparatus, the process comprising:
acquiring a first free space of a first storage unit used for writing data when a request to write the data in a first storage device is given;
writing the data in the first free space,
requesting that a transfer-destination storage control apparatus acquire a second free space used for writing the data before writing the data in the first storage unit in the writing process has been completed, the transfer-destination storage control apparatus being provided with a second storage unit for storing data to be written in a second storage device; and
transferring the data written in the first storage unit to the transfer-destination storage control apparatus.
